(19) United States
(12) Patent Application Publication
(10) Pub. No.: US 2004/0105655 A1
(43) Pub. Date: Jun. 3, 2004

(54) Rack system for high performance audio/video components

(76) Inventor: Joseph S. Ciulla, New York, NY (US)

Correspondence Address: Joe Ciulla, 109 E. 36th Street, New York, NY, 10016, US

(21) Appl. No.: 10/717,259

(22) Filed: Nov. 19, 2003

Related U.S. Application Data
(60) Provisional application No. 60/428,458, filed on Nov. 22, 2002.

(51) Int. Cl. H04N 5/76

(52) U.S. Cl. 386/46

(57) ABSTRACT

A rack system for use with high performance audio and video components is described. Preferred embodiments of the rack system are customizable and modular comprising horizontally and vertically extending elongated sections of strut channel that are secured together with cap screws and channel nuts. Components are supported on the rack by way of specially configured mounts, as the preferred embodiment racks are shelfless. The mounts typically include one or both of a constrained layer of viscoelastic damping material and a bearing assembly to help isolate the components and to absorb vibration energy passing through the rack or generated by a component. The mounts also typically include a threaded stud that extends from one side and facilitates the attachment of the mounts to horizontally orientated strut channel elements.

### REFERENCE TO RELATED APPLICATIONS

This application claims priority to the provisional application No. 60/428,458 filed on Nov. 22, 2002 entitled “Equipment rack with vibration damping and isolation elements”, and having the same inventor as this application.

### FIELD OF THE INVENTION

This invention relates generally to field of high performance audio recording and reproduction, and more specifically to a rack system and associated mounts for supporting high performance audio/video components.

### BACKGROUND

The electronic components of ultra high performance audio/video systems have advanced to the point where they can record and reproduce music and video with extreme accuracy. Although there remain improvements that can be made in the arena of these electronics, the potential magnitude of any improvements is becoming increasingly smaller.

As the components become perfected, the limitations on accurate music/video recording and reproduction caused by self-generated and externally induced vibrations into components become more and more noticeable and relevant. Mechanical and electrical vibration if unchecked, whether at gross magnitudes that can be felt by a person who touches a component or the supporting shelf and rack, or at submicron magnitudes, can cause time and frequency domain disturbances that can have a real effect in limiting an audio/video system from achieving its full potential. In other words audio/video electronic componentshave advanced beyond the state of the art vibration control systems to such a degree that improvements in vibration control offer the greatest potential in providing further improvements in music/video recording and reproduction. Significant effort has been made to minimize and damp-vibration to prevent it from negatively effecting component performance, whether the vibration is caused by: (1) acoustic resonance resulting from playing music, (2) minor seismic disturbances, vehicular traffic, foot-fall, and loudspeaker to floor energy transfer; or (3) movement within the component itself, such as the spinning of a compact disk or record, or vibrations from a transformer.

To minimize the harmful effects of vibration, most rack systems use shelves or platforms for component support that are designed to provide damping of vibratory energy that may enter the rack in an attempt to “isolate” the supported component. However, shelves and platforms create inadvertent problems caused by their mass, shape, and large surface area which makes them particularly susceptible to torsional, or twisting forces caused by resonant modes. A (large) shelf can easily be “excited” or energized by airborne and rack-borne vibratory energy—especially at high volume and low frequencies. In this manner, a shelf designed to minimize vibratory energy actually works against its self by “encouraging” extra overhead. This unwanted excess energy may “reflect” back into the component, causing degradation of performance. Moreover, since the shelf is separate from the rack, and most often constructed of dissimilar materials with different resonant frequencies, they will produce different bending mode shapes which will likely cause problems. Finally, many platforms add significant unnecessary weight to a rack, which is undesirable, and thick platforms reduce headroom for components. At best, only the most sophisticated and expensive shelves can begin to address but not eliminate these problems.

Furthermore, a rack system comprised of shelves that support components by their stock feet provides no effective means to drain harmful component-generated, and acoustically induced vibratory energy into the shelf where it may be damped. With few exceptions, the vast majority of components have “rubber” feet that do not permit this energy transfer. Therefore, third-party or optional coupling devices, such as “cones”, “footers”, and “bearings” must be placed between the component chassis and the shelf. While the addition of these couplers may be of some benefit, one must note their inherent shortcomings and oftentimes-high costs. Coupling devices lift components off their feet and reduce rack headroom, and they place significant mass between a shelf and the supported component. Vibratory energy within the component must flow through these devices to be damped by a shelf. But, with very few exceptions, those devices of the “hard” variety impede this critical flow while causing “noise” to reflect back into the component due to the “high-loss” (internal friction), and resonant quality of their poorly chosen materials. Alternately, while “soft” footers may not create “noise”, they fail almost entirely as energy conduits, and they tend to diminish resolution and dynamics. Furthermore, the placement of three or four couplers on a single shelf may encourage “cross-talk” of vibratory energy whereby some frequencies may “leak” back into the component. For instance, if one coupler positioned directly below a transformer inside a component receives a disproportionately large amount of vibratory energy, it would not be desirable to “feed” that energy back into any or all of the other couplers, or allow it to mix and linger with other frequencies in the platform.

Finally, rack designs typically include a metal spike or cone at the bottom of the supporting columns to provide the rack with solid coupling to the floor. However, they do nothing to prevent harmful floor-borne vibratory energy from entering the rack and degrading the performance of the supported components.

Ultimately, to minimize the performance degradation due to vibration and maximize audio performance, a unified system is needed that is specifically designed to synergistically combat the issue of vibration. Unfortunately, such a solution is not currently available in the prior art.

### SUMMARY OF THE INVENTION

One preferred embodiment of the invention comprises a rack system for supporting audio/video components. The rack system comprises a plurality of generally horizontal elongated elements and a plurality of generally vertical elongated elements. Each horizontal elongated element of the plurality thereof is comprised of strut channel and includes a longitudinally extending slot. The vertical elongated elements are adapted to couple with the horizontal elongated elements to form a freestanding structure. The rack system also includes a plurality of mounts. Each mount of the plurality of mounts includes an at least partially threaded stud extending from one side thereof. Finally, the rack system includes a plurality of channel nuts with threaded bores. Each channel nut is adapted to (1) be received into the elongated slot of at least one of the horizontal elongated elements, (2) braced against an inside surface of the horizontal elongated element, and (3) receive the at least partially threaded stud in the threaded bore.

Another preferred embodiment of the invention also comprises a rack for supporting audio and video components. This rack includes a plurality of substantially vertical columns, a plurality of substantially horizontal first elongated members, and a plurality of substantially horizontal second elongated members. The columns, the first elongated members, and the second elongated members are comprised of strut channel. Each of the plurality of the first elongated members is attached to at least one of the vertical columns, and each of the plurality of second elongated members is attached to at least one of the first elongated members. Accordingly, the combination of the columns, the first elongated members and the second elongated members form a self-supporting structure. Finally, the rack includes at least three mounts that are coupled with the self-supporting structure.

Yet another preferred embodiment of the invention comprises a rack having a structure comprised of strut channel in combination with at least one audio/video component supported on the rack.

### BRIEF DESCRIPTION OF THE DRAWINGS

FIGS. 1-4 illustrate respective isometric, front, top and side views of a first preferred embodiment rack system of the present invention.

FIGS. 5 & 6 illustrate respective side and top views of a cross bar member of the rack structure.

FIGS. 7, 8 & 11 illustrate respective side, bottom and cross sectional views of a tie back member of the rack structure.

FIGS. 9, 10, & 12 illustrate two side views and a cross sectional end top view respectively of a vertical column of the rack system.

FIG. 13 illustrates a cross bar member fitting attached to a tie back member according to an embodiment of the present invention.

FIG. 14 illustrates a bearing mount attached to a cross bar member according to an embodiment of the present invention.

FIG. 15 is an isometric illustration of the channel nut according to one embodiment of the present invention.

FIGS. 16-19 illustrate two variations of cross bar members having a constrained layer of viscoelastic material bonded thereto according to an embodiment of the present invention.

FIGS. 20-22 illustrate front, side and top views of a second preferred embodiment of the rack system.

FIGS. 23-25 illustrate top, side and cross sectional views of the bridge member according to an embodiment of the present invention.

FIG. 26 illustrates a three-way corner bracket according to an embodiment of the present invention.

FIGS. 27 & 28 illustrate respective front and side views of a third preferred embodiment of the rack system

FIGS. 29-34 illustrate various views of a fourth preferred embodiment of the rack system.

FIGS. 35-37 illustrates top, cross sectional and side views of a base member cross bar according to an embodiment of the present invention.

FIG. 38 is an exploded side view showing a modified base member and side views of the base member cross bar fitting and the second modified cross bar member fitting that interface therewith according to an embodiment of the present invention.

FIG. 39 is a top view of the second modified cross bar fitting according to an embodiment of the present invention.

FIGS. 40 & 41 are side and side isometric view of a simple platform mount according to one embodiment of the present invention.

FIGS. 42 & 43 are respective isometric side and cross sectional side views of a self-adjusting platform mount according to one embodiment of the present invention.

FIGS. 44 & 45 are respective isometric side and cross sectional side views of a second self-adjusting mount according to one embodiment of the present invention.

FIGS. 46 & 47 are a side view and an exploded isometric view of a simple bearing mount according to one embodiment of the present invention.

FIG. 48 is a side view of a bearing mount having a single disc according to one embodiment of the present invention.

FIGS. 49 & 50 are a cross sectional view and a partial exploded cross sectional view of a first type of bearing mount incorporating an O-ring according to one embodiment of the present invention.

FIGS. 51 & 52 are an isometric side view and a cross sectional isometric side view of a second type of bearing mount incorporating an O-ring according to one embodiment of the present invention.

FIGS. 53-55 are side views of several types of platform mounts incorporating one or more layers of viscoelastic material according to one embodiment of the present invention.

FIG. 56 is a cross sectional front view of a hybrid bearing mount according to one embodiment of the present invention.

FIGS. 57-63 are front views of various configurations of hybrid bearing mounts according to one embodiment of the present invention.

FIGS. 64-71 are front and top views of various mount interface surfaces according to one embodiment of the present invention.

FIGS. 72-74 are front views of multileveled rack systems having components supported thereon using different types of mounts according to one embodiment of the present invention.

FIG. 75 is a bottom view of a typical component illustrating exemplary locations for positioning the mounts according to one embodiment of the present invention.

FIGS. 76-77 are views relating to the use of a bearing mount in place of a floor spike to support a column of the rack structure on a ground surface according to one embodiment of the present invention.

FIGS. 78-79 are front views of an alternative bearing mount having a spiked interface surface for use in supporting with a rack or loudspeakers on a carpeted floor according to one embodiment of the present invention.

FIGS. 80-82 are various views of a first type spike adapter configured to support a bearing mount having a flat interface surface securely on a carpeted floor according to one embodiment of the present invention.

FIGS. 83 & 84 are isometric views of a second type spike adapter with adjustable spikes according to one embodiment of the present invention.

FIGS. 85 and 86 are isometric views of an adapter with adjustable feet utilized to receive the stud of a mount therein when supporting components or speakers sans a rack according to one embodiment of the present invention.

FIGS. 87-94 are various partial and whole views of a triangular rack system according to one embodiment of the present invention.

### DETAILED DESCRIPTION

Overview

A shelf-less integrated rack system and associated component mounts are described herein. Advantageously, preferred embodiments of the present invention provide an integrated approach to minimizing vibration comprising a rack, various mounts for supporting specific components on the rack, and various floor connectors for securely coupling the rack to a floor. Further, damping means in the form of layers of viscoelastic material are provided in various locations on the rack system to dissipate vibrational energy.

The preferred embodiments of the rack system are customizable and modular, permitting the rack to be specifically configured according to the number and type of components to be supported thereon. Using the various elements of the rack system, different racks can be constructed that are adapted to support: (1) one component per level; (2) two components per level; and (3) loudspeakers individually. Additionally, the number of levels of the rack can be varied.

One of the several key benefits of the rack system is the elimination of shelving. Shelves in traditional racks require that special consideration be paid to damping vibration of the shelves, as well as, preventing the introduction of additional vibration into the system through the shelves. Even with well-engineered shelves, if maximum performance from the component is desired, coupling devices or mounts are also typically used to raise the associated component off of its stock feet. As can be appreciated, having to provide both engineered shelves and coupling devices or mounts can significantly increase the total cost to assemble a suitable prior art rack system. By eliminating the shelving and directly coupling the mounts to the rack structure, embodiments of the present invention eliminate one component of the prior art rack system thereby reducing costs. Further, by eliminating the shelving and directly attaching the mounts to the rack structure, the possibility of mechanical vibration being introduced by the shelves is eliminated, and the transmission and damping isolation of vibration can be more precisely controlled by providing a more direct and more efficient “drainage path” for vibration that is transmitted into the mounts from the associated components. Several additional and not insignificant benefits of eliminating shelving that do not relate to vibration control include greater headroom between levels, simplified cabling, superior component ventilation and easier component cleaning.

Embodiments of the present invention also include several new and innovative mounts that offer superior vibration transmissibility, superior damping, and in the case of the bearing mount, superior vibration damping of and isolation from laterally directed vibrational energy. Several embodiments of the mounts include one or more viscoelastic layers to damp vibrational energy by dissipating it as low-grade heat. Other embodiments of the mounts include a mounting stud that easily interfaces with and attaches to the rack of the rack system. Even other embodiments are adapted to self-level the mount against the bottom of a component so that full contact is made therewith even if the component's bottom is not completely flat. Finally, spiked adapters are provided for using certain embodiments of the mounts directly against carpet or other soft/resilient floor coverings to either directly support components, loudspeakers, or the rack itself.

Terminology

The term “or” as used in this specification and the appended claims is not meant to be exclusive rather the term is inclusive meaning “either or both”.

The term “components” generically refers to any components from an audio/video system such as, but not limited to, a CD burner/player, a DVD burner/player, a turntable, a tape player/recorder, an amplifier, a receiver and a VCR.

The terms “channel”, “channel element” in singular and plural forms all refer to what is known commercially as “strut channel” unless specifically indicated otherwise. “Strut channel” as used in herein refers to the commonly accepted meaning of the phrase, as well as, pertaining to any elongated channel formed of any suitably stiff material that includes a longitudinally extending slot into which a nut can be received that when tightened by a screw, rivet or other fastener braces the nut against an interior surface or portion of the channel.

Typically as used herein, the term “mount” or “mounts” refers to any relatively small structure when compared to the size of a component or the rack structure that is used in groups of three or more to support a component on a rack system. In the preferred embodiments of the rack system, the mounts are coupled directly to horizontal elements of the rack structure, but in other and alternative embodiments, the mounts can be set upon a floor, on a specially configured adapter, or on a shelf. In other configurations, the mounts can be used to support the rack structure itself in place of floor spikes. Depending on the embodiment of the mount, the mount may include, but is not limited to: a ball bearing that can move in one or two associated races; a carbide ball that is rotationally fixed between two discs; a disc with a stud protruding therefrom; and two or more discs having one or more constrained layers of viscoelastic material bonded therebetween.

“Bearing assembly” as used herein refers to the combination of at least one ball bearing and at least one race. The term is typically used in connection with “bearing mounts” , which are mounts that comprise a “bearing assembly”.

The Rack System

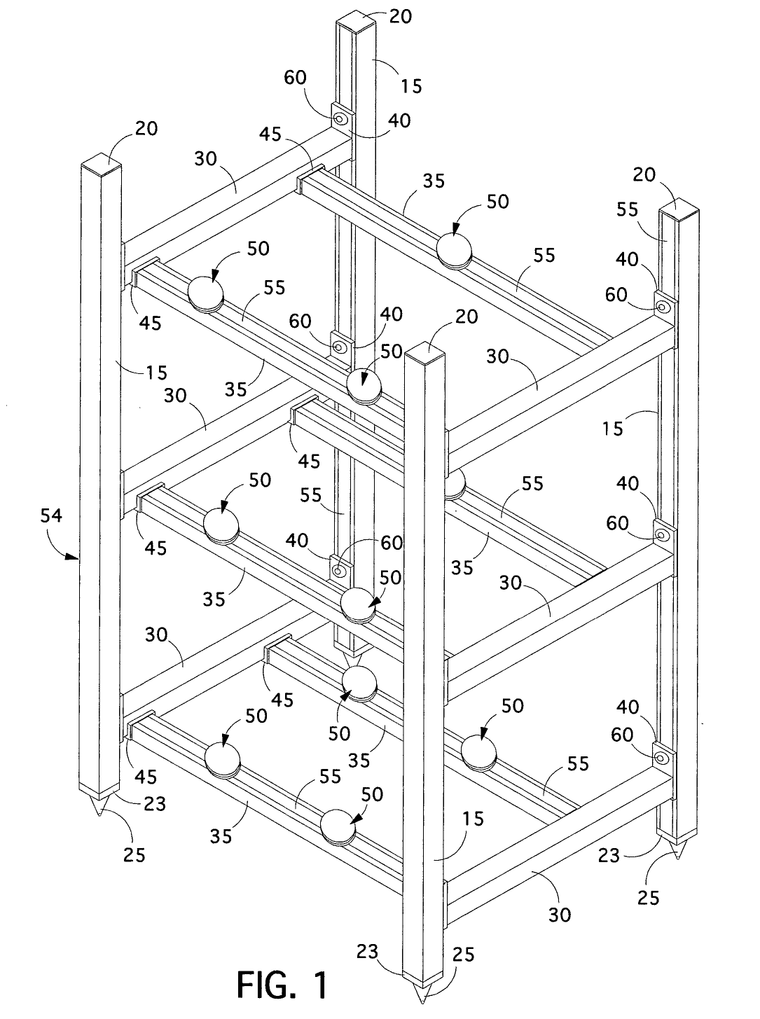

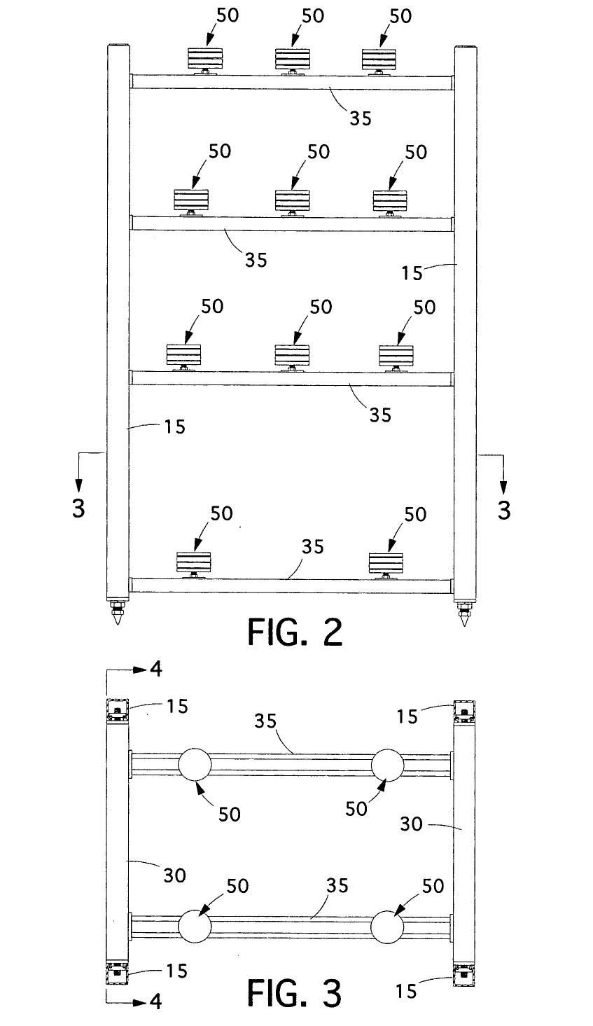

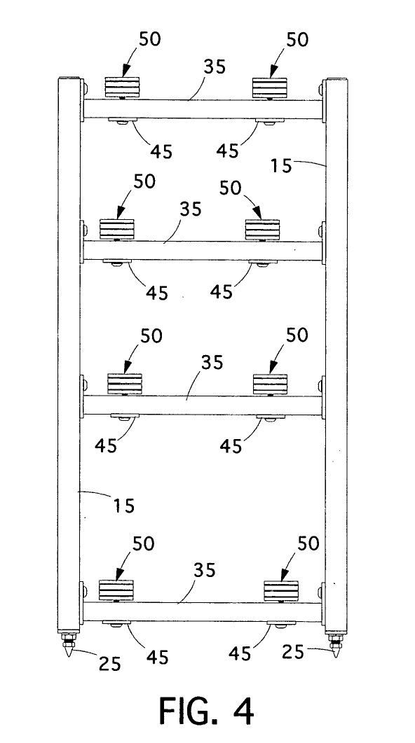

Referring to FIGS. 1-19, a first preferred embodiment 10 of the rack system and its various elements are illustrated. The rack structure comprises a plurality of elongated modular channel elements including: (1) four columns 15; (2) a pair of horizontal tie back members 30 to join the front and rear columns at each level of the rack; (3) at least two horizontal cross bar members 35 for each level that span between right and left tie back members. The illustrated variation of the first preferred embodiment has a height of about 44″, a depth of about 21¾″, and a width of about 27¾″. Further, the illustrated rack structure has three levels.

The aforementioned elongated modular channel elements are generally comprised of rectangular or square cold-rolled steel strut channel having a width of about 1⅝″, a thickness of about ¼″, and a depth that varies from 1″ to 1⅝″ depending on the channel element and its respective design loads. Each of the channel elements, however, includes an elongated slot 55 that extends longitudinally the length of one side of the element. The slot is typically about ⅞″ wide and is centered relative to the edges of its associated side of the elongated channel element. In the preferred embodiments the channel elements are zinc plated to give the channel an attractive satiny silvery finish. Referring briefly to FIG. 11, a cross section of a tie back member 30 is shown that illustrates the construction of the channel elements. The slot is defined on either side by a pair of in-turned edges 75. Variations of the elongated channel elements can be fabricated from other materials including plastics, composites, aluminum, magnesium and other metals. Further, the dimensions of the elongated channel elements can vary depending on the intended use of the channel element and the material it is constructed from.

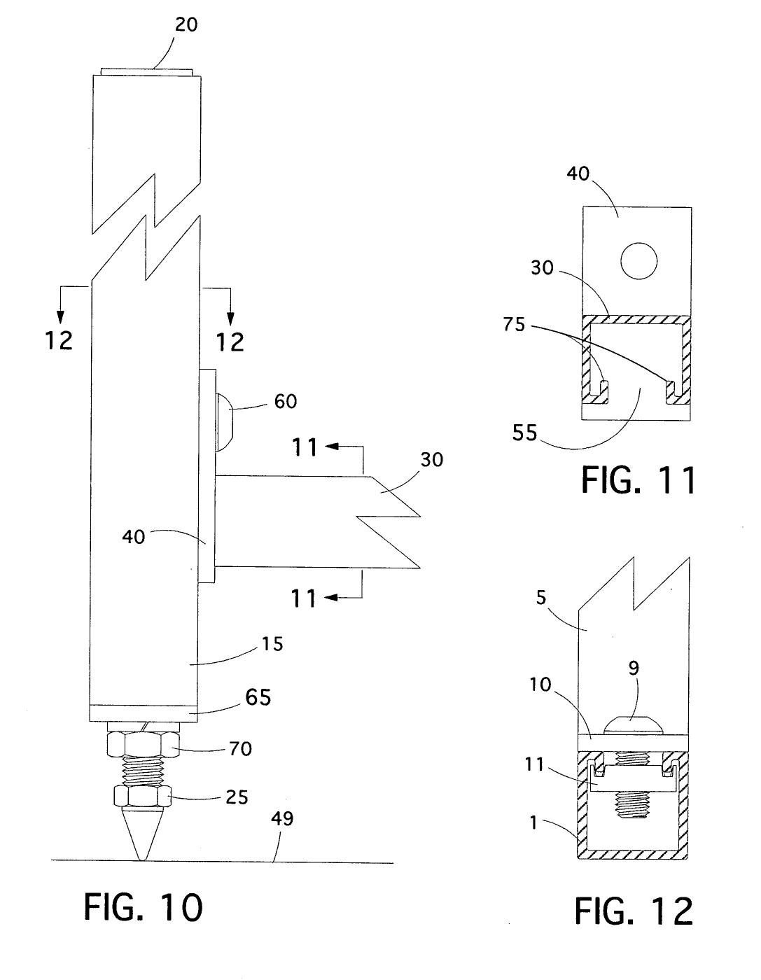

Each of the four columns 15 are vertically orientated with the slot 55 of each facing either rearwardly or forwardly depending on whether the column is a front or rear column respectively. A typical column is individually illustrated in FIG. 9. Each column typically includes end cap 20 comprising ¼″ steel plate welded or otherwise joined to the top end of the column. A planar steel bottom plate 65 including a threaded bore is welded to the bottom end of each column. Typically, a threaded and height adjustable floor spike 25, such as shown most clearly in FIG. 10, is threaded into the bottom plate. The floor spike typically includes a jam or lock nut 70 for bracing against the bottom plate and fixing the spike at a desired height. The floor spike of the first preferred embodiment comprises ⅝″11 threaded steel rod terminating in a conical bottom end. By individually adjusting the spike of each column independently, a user can level the rack on floors or other ground surfaces that are not completely level. Specially adapted mounts can be used in place of the floor spikes in certain variations of the first preferred embodiment 10 and other embodiments of the rack system as will be described in greater detail below. The lengths of the columns can vary significantly depending on the number of rack levels and the spacing between each level.

The right front and rear columns 15 are coupled by way of tie back members 30. Each of the right and left sides of the rack structure comprises a tie back member for each rack level, thereby forming a ladder structure with the associated columns. Typically, the slot 55 of each tie back member is downwardly facing. Side and bottom views of an individual tie back member are illustrated in FIGS. 7 and 8 respectively. Each tie back member has a tie back end fitting 40 welded on to both of its ends. The tie back end fitting generally comprises a rectangular steel plate of which a portion extends beyond the side of the tie back member opposite the slot. A bore is provided in the end fitting to receive a cap screw 60 therethrough. Typically, the cap screw is a ½″13 steel alloy button-head hex socket fastener, although others can be utilized.

Referring specifically to FIG. 12, the tie back member 30 is attached to a column 15 by butting the outside surface of the tie back end fitting 40 against the slotted side of the column, placing the cap screw 60 through the bore in the tie back end fitting, and threading and tightening the cap screw in a threaded bore 105 (see FIG. 15) of a channel nut 80. The channel nut has two opposed grooves 95 that interface with the in-turned edges 75 of the column's slot to secure the tie back member to the column. Additionally as shown in FIG. 15, the grooves include a plurality of serrations or splines 100 that bite into and deform the steel of the in-turned edges immediately where they contact the in-turned edges to securely attach the two channel elements and prevent the tie back members from moving or sliding vertically downwardly when loaded. It is to be appreciated that by using this particular method of joining the tie back members and the columns, the position of a particular column and incidentally an associated level of the rack can be positioned at any desirable location along the length of the column. Further, the vertical positions of the tie back members can be finely adjusted to help ensure the associated level of the rack is in fact level to a degree desired by a user.

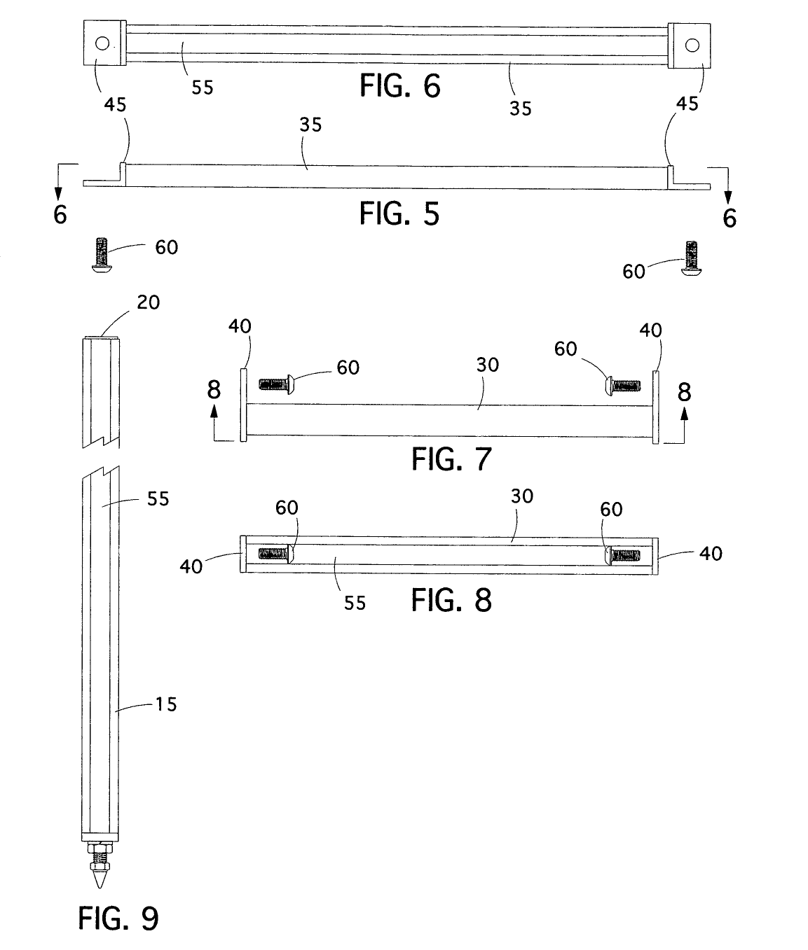

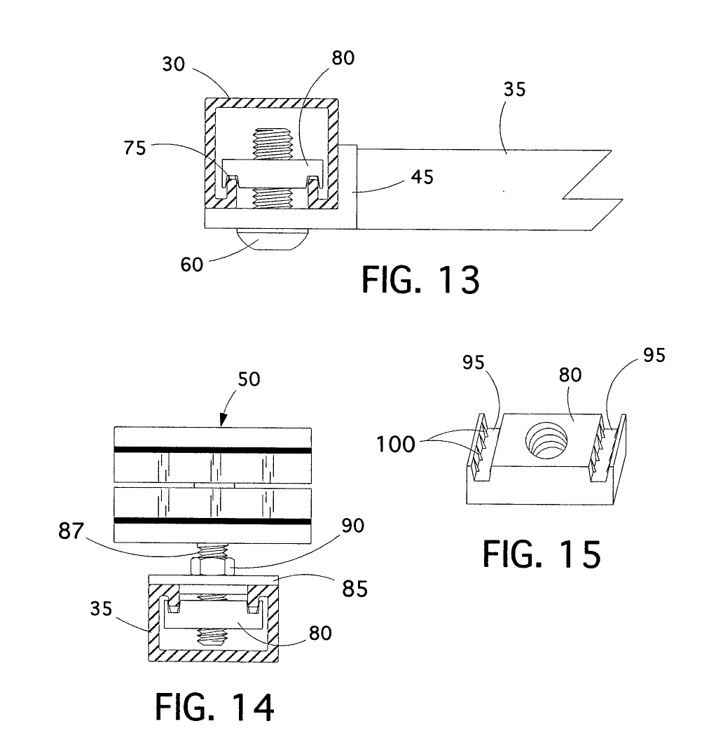

For each level of the rack structure, at least two horizontal cross bar members 35 extend between the left and right tie back members 30. Generally, the slotted sides of the cross bar members are facing upwardly to receive one or more mounts, such as the illustrated bearing mounts 50, therein. Top and side views of an individual cross bar member are illustrated in FIGS. 5 and 6 respectively. Each cross bar member has a cross bar end fitting 45 welded on to both of its ends. The cross bar end fitting generally comprises an L-shaped steel bracket wherein the vertical leg of each bracket is welded to an end of the cross bar member, and wherein the horizontal leg of the L-shaped member extends outwardly and includes a vertically extending bore therethrough. Referring to FIG. 13, to attach a cross bar member to its associated tie back members, a cap screw 60 is received through the bore of each end fitting, fed up into the slot of a corresponding tie back member, and is threaded and tightened to a channel nut 80 in much the same manner as described above concerning the attachment of the tie back member to the column 15. It is appreciated that the cross bar members can be precisely positioned anywhere along the associated tie back members to effectively accommodate audio components of varying depths.

Three or four mounts, such as the illustrated bearing mounts 50, are coupled to the cross bar members 35 by way of a threaded stud 87 extending from the mount and a channel nut 80 contained in the cross bar member 35. To brace against the outside surface of the slotted side of the cross bar member and tightly secure the mount in place at the proper height, a mount washer 85 and an associated lock nut 90 is provided. The threaded stud of the mount and the use of the mount washer and lock nut permits the height of each mount to be independently adjusted to help ensure the top interface surface of all associated mounts are level relative to each other or staggered in such a manner to account for any topographic features on the bottom surface of a component to be supported. Typically, only three mounts are required to adequately support a component with the heavier side of the component being supported with two mounts; however as desired four mounts or more can be utilized with any component. Any of the variety of mounts described below can be utilized with the first preferred embodiment 10 depending on the degree of damping, isolation, and coupling or decoupling a user hopes to achieve concerning an associated component.

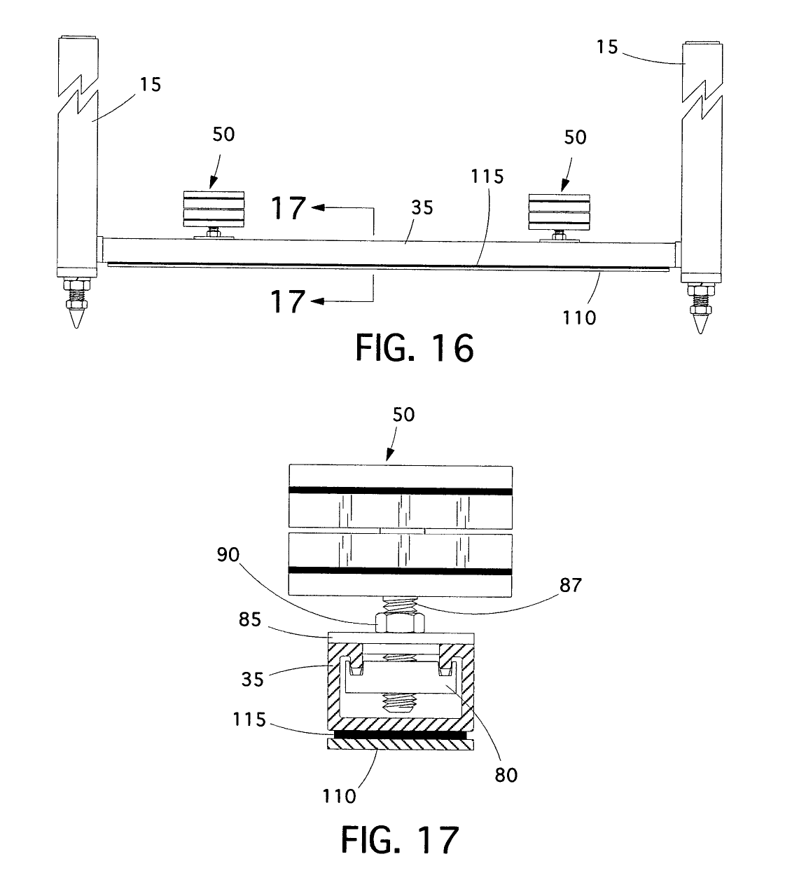

Referring specifically to FIGS. 16-19, two variations of the cross bar members 35 are provided that incorporate constrained layers of viscoelastic sheet material 115 to damp the cross bar member. One type of viscoelastic sheet material that has been found to be effective for use in the cross bar member variations and for use associated with the various mounts is Isodamp C-1000 series thermoplastics by Aearo E.A.R specialty Composites of Indianapolis, Ind. As illustrated in FIGS. 16 and 17, the viscoelastic material can be bonded directly to the bottom side of a standard cross bar member with the other side of the viscoelastic material layer being bonded to a constraining layer 115. The constraining layer typically comprises a strip of rigid material, such as steel, having similar properties as the material of the cross bar member's elongated element. Ideally, the constraining strip is at least as thick as the wall thickness of the corresponding side of the cross bar member.

When vibration of an associated component resident on mounts 50 attached to the damped cross bar member 35 is transmitted through one or more associated mounts into the cross bar member, the cross bar member flexes. The flexure causes shear loads to be introduced into the viscoelastic damping material layer 110 that converts the vibratory energy into low-grade grade heat by way of hysteresis. Any heat is quickly conducted away from the damping layer into the rack's metal structure where it is dissipated. Additionally, at least a portion of the—vibratory energy introduced to the cross bar member by way of the tie back members 30 via the columns 15 and the floor on which the rack resides is also converted to low-grade heat.

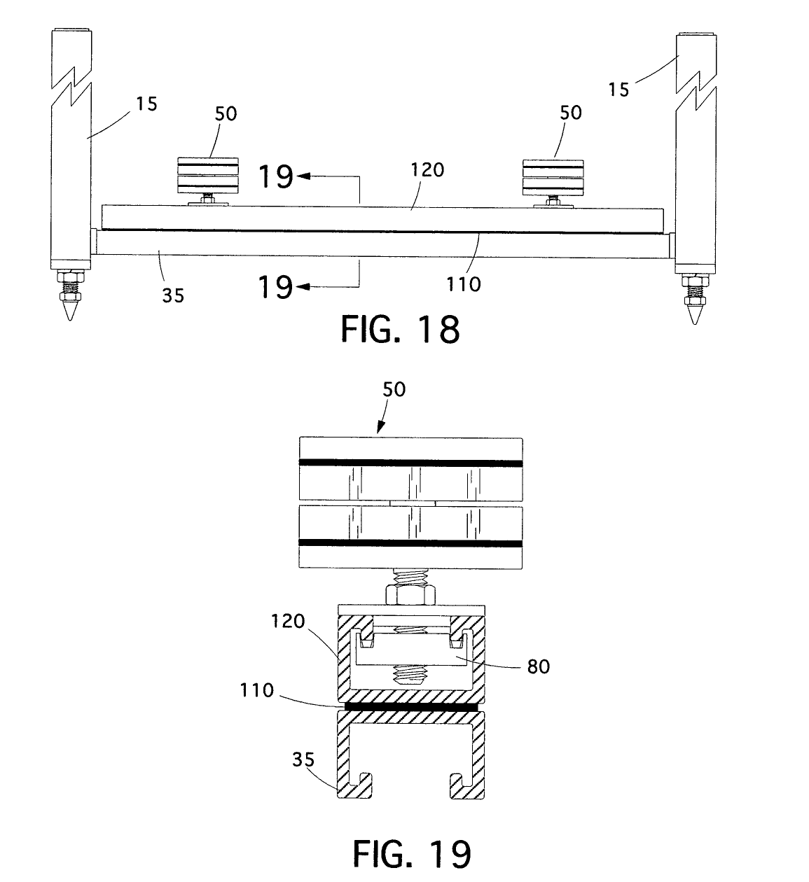

To maximize the amount of vibrational energy potentially converted into heat by the viscoelastic damping layer 110, the stiffness of the constraining layer should preferably be at least as stiff as the associated elongated channel element of the cross bar member 35. A variation of the cross bar member 35 incorporating an associated viscoelastic layer 110 constrained by an additional elongated channel member 120 to which the mounts 50 are directly attached is illustrated in FIG. 18 and 19. In this variation, the cross bar member 35 is typically mounted to its associated tie back members 30 with its slotted side facing downwardly instead of upwardly. The viscoelastic layer is adhesively bonded to the top facing side of the cross bar member and the additional elongated channel member 120 is adhesively bonded to the top side of the viscoelastic layer with the slotted side of the channel member facing upwardly to receive mounts therein. This variation effectively isolates the additional channel 120, the mounts 50 and an associated component from a significant portion of the vibrational energy that propagates through the rack structure.

It is to be appreciated that other configurations of a viscoelastic material layer 110 constrained between the cross bar member 35 and a stiff constraining layer are contemplated as would be obvious to one or ordinary skill in the art given the benefit of this disclosure. Furthermore, viscoelastic layers can be adhesively affixed to the different elongated channel elements of the rack structure, such as the columns 15 and the tie-back members 30, using similar materials and construction as detailed for the cross bar members 35.

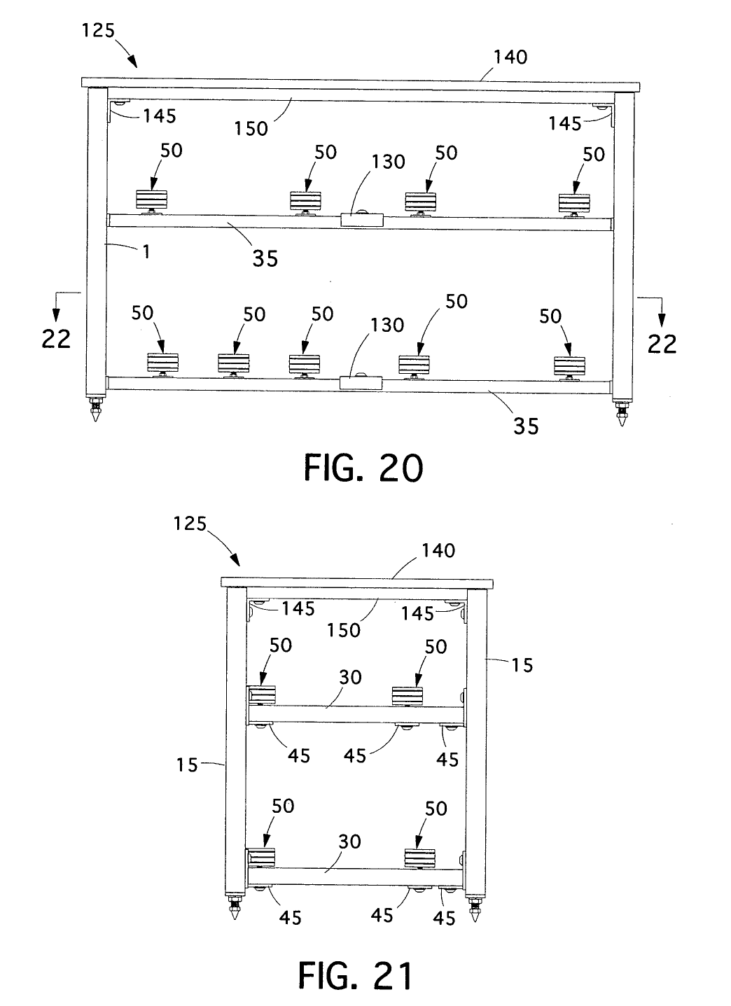

Referring to FIGS. 20-26, a second preferred embodiment 125 of the rack system and its various channel elements are illustrated. The second preferred embodiment rack structure generally comprises essentially all the same components of the first preferred embodiment 10, as well as, several additional components to permit the construction of a rack that is effectively twice the width of the first preferred embodiment. Further, the various channel elements of the second preferred embodiment are joined together in the same manner as the first preferred embodiment. Accordingly, as shown in FIGS. 20-22 specifically, the second preferred embodiment includes: (1) columns 15; (2) horizontal tie back members 30; (3) horizontal cross bar members 35 of at least two different lengths; (4) a bridge member 130 to span the front and rear long cross bar members and permit shorter cross bar members to span between it and the right and left sides tie back members of a particular rack level; and (5) front/rear stringers 135 and left/right stringers 150 for supporting a television shelf 140. The double width second preferred embodiment can be utilized as a television stand and is specifically adapted to support two different audio/video components at each provided shelf-less rack level. The illustrated variation of the second preferred embodiment has a height of about 28″ to 35″, a depth of about 21″ to 23″, and a width of about 45″ to 47″. Further, the illustrated rack structure of the second preferred embodiment has two shelf-less levels.

As mentioned above, the construction of the double width rack is essentially the same as the first preferred embodiment. The columns 15 are secured to the tie back members 30 to form a ladder structure, and front and rear long cross bar members 35 are secured to the tie back members for each associated rack level. The primary differences in construction concern the bridge member 130, the shorter cross bar members 35 that are secured between one tie-back member of a level and the bridge member, and the stringers 135 & 150 associated with the television shelf.

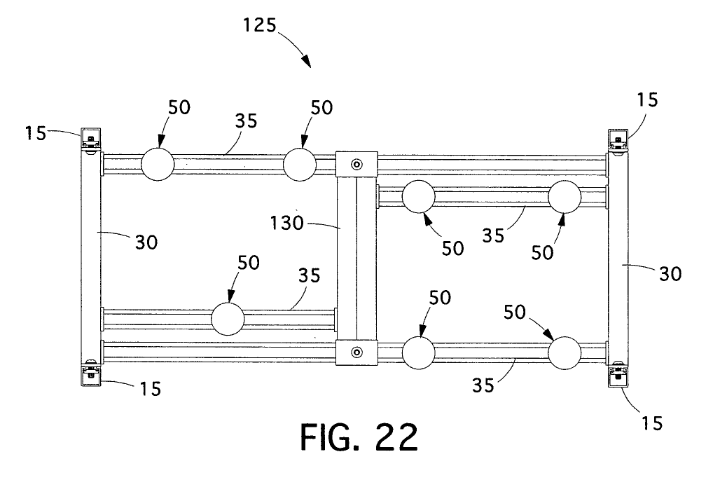

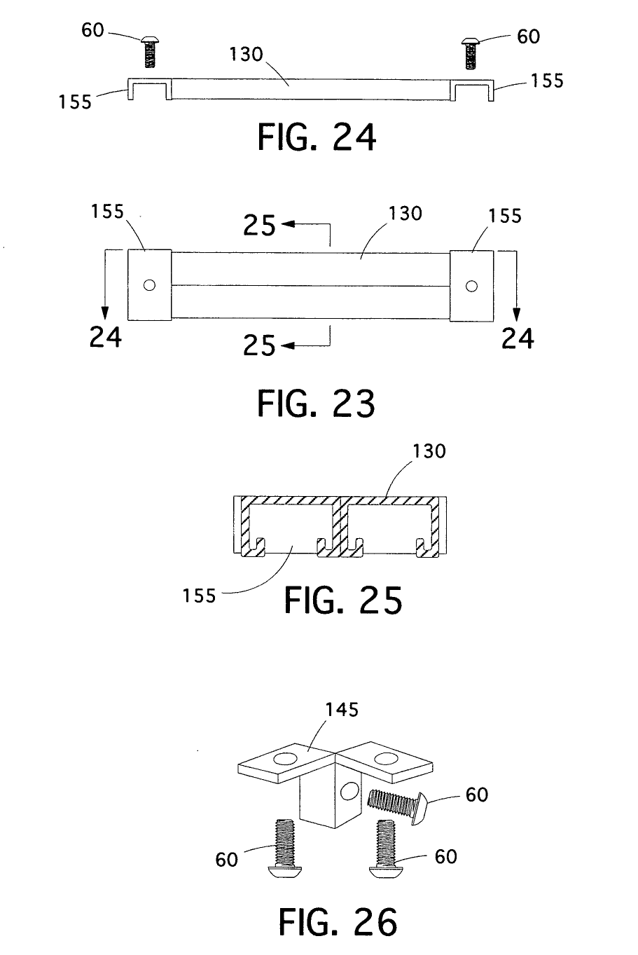

As is best shown in FIGS. 23-25, the bridge member 130 comprises two channel elements situated side-by-side with both of their slotted side facing downwardly. The channel elements have C-shaped end fittings 155 welded to the ends thereof with the open end of the C-shape facing downwardly. A bore is provided through the end fittings to receive a cap screw 60 therethough. Accordingly, as best shown in FIG. 22, the bridge member can be laid across the front and rear long cross bar members 35 perpendicularly and secured to the cross bar members by way of the cap screw and a channel nut 80 contained in the slots 55 of the respective front and rear long cross bar members.

Optionally, shorter cross bar members can be secured to a tie back member 30 and the bridge member 130 on either or both sides of the bridge member. Since the spacing of the front and rear long cross bar members 35 is fixed by the length of the bridge member they may not be able to be utilized to support all components since the depth of a particular component may be less that the spacing between the long cross bar members. By using the short cross bar members, which a user can slide and secure anywhere along the tie back member and the bridge member, components having a shallow depth can be supported by attaching one or two mounts 55 to either of the front or rear long cross bar members and attaching the corresponding one or two mounts to the associated short cross bar member as is best illustrated in FIG. 22.

Referring back to FIGS. 20 and 21, stringers 135 & 150 extend between the columns 15 proximate their top end. The stringers are orientated with their slot 55 facing downwardly and are secured to the columns by way of a three-way corner bracket 145 (as shown individually in FIG. 26) that attaches to the columns and the stringers by way of cap screws 60 and channel nuts 80 that are received in the appropriate slots. A platform or shelf 140 is placed on the stringers to support a television set or other component.

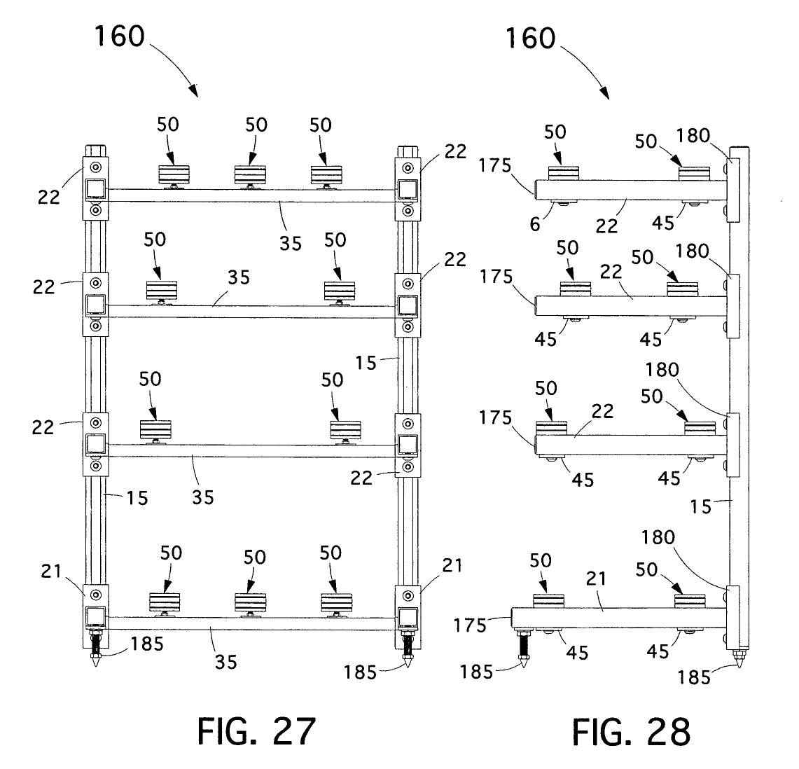

Referring to FIGS. 27 & 28, a third preferred embodiment 160 of the rack system and its various elements are illustrated. The third preferred embodiment rack structure generally comprises similar channel elements as the first preferred embodiment 10, but instead of utilizing four columns 15 the third preferred embodiment only has two with a pair of cantilever members 170 (generally analogous to the tie back members 30) for each rack level and a pair of base members extending 165 forwardly from the column members proximate the bottom ends of the column members. The illustrated variation of the third preferred embodiment has a width and height similar to those of the illustrated first preferred embodiment 10, but in general the depth is slightly less at around 18″ for the elevated levels and around 20″ for a base level associated with the base members 165. Additionally, a double width variation of the third preferred embodiment can be fabricated by using longer cross bar members 35, a bridge member 130, and several short cross bar members in a similar fashion as described above concerning the second preferred embodiment 125. The illustrated rack structure of the third preferred embodiment has three elevated levels and one base level.

The pair of base members 165 are attached to the pair of columns 15 proximate a bottom end of each column and extend therefrom at substantially a right angle. The base members typically have their slotted sides facing downwardly. Each base member includes two base member end fittings 180 that are generally C-shaped (or U-shaped) and fit over the end of the adjacent portion of the column. Unlike the end fittings of the tie back members discussed above, the base member end fittings extend both above the top of the associated channel element and below the bottom of the associated channel element and include bores in both of the upwardly and downwardly extending portions, wherein a cap screw 60 is received to secure the base member to the column by way of a channel nut 80 residing in the slot 55 of the column. By securing the base member to the column with two cap screws and using a C-shaped fitting whose sides interface with the unslotted sides of the column that are adjacent the slotted side, a vertically and torsionally rigid connection with the column is provided.

Each base member also includes an end cap 175 that is typically welded to the front end of each base member. Finally, the base member includes a spike assembly 185 that is generally similar to the adjustable floor spike 25 that is attached to the bottom ends of the column 15. The floor spike assembly 185 differs in that it includes a washer essentially the same as the bearing mount washer 85 and a channel nut 80 so that the assembly can be received into the slot 55 of the base member and secured therein. The spike assembly can be secured to the base member anywhere along its length but is typically and advisably secured proximate the end of the base member to maximize the support and stability of the rack 160.

The third preferred embodiment also comprises a pair of cantilever members 170 in place of tie back members 30 for each of the racks elevated levels. The cantilever members are in almost all respects the same as the base members except they are slightly shorter (typically 18″ versus 20″) and they do not include a spike assembly 185. For instance, they use the same type of C-shaped fitting for attachment to the columns 15. As with the tie-back members 30, the vertical position of the cantilever members along the associated columns is infinitely adjustable.

Concerning the cross bar members 35, they attach to the cantilever members 170 in the same manner that the cross bar members of the first preferred embodiment attach to the tie back members 30. Further, the mounts 50 attach to the cross bar members in the same manner described above in reference to the first preferred embodiment.

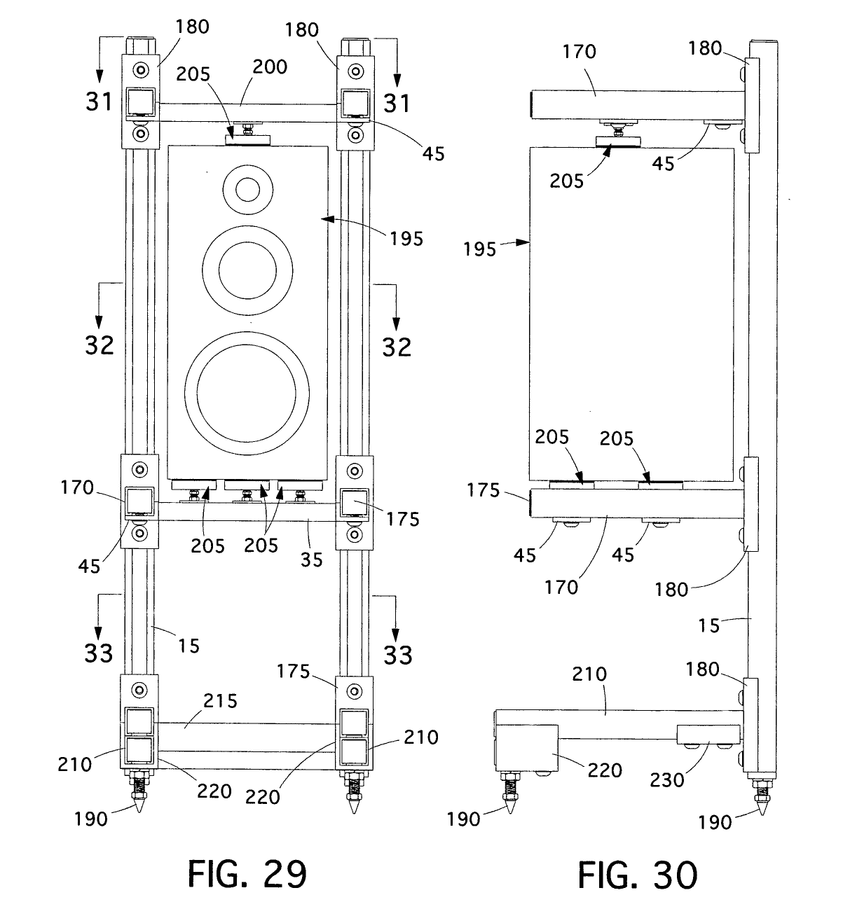

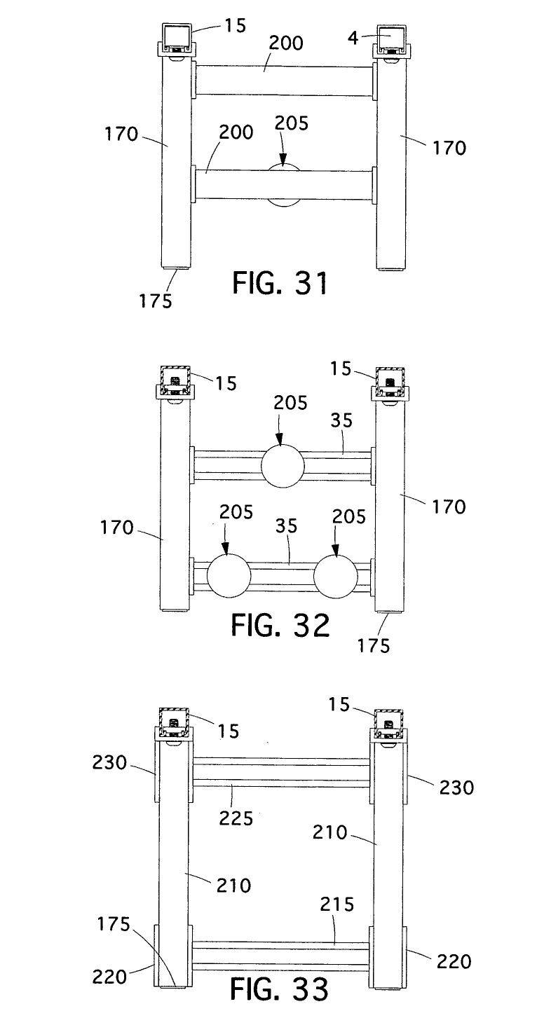

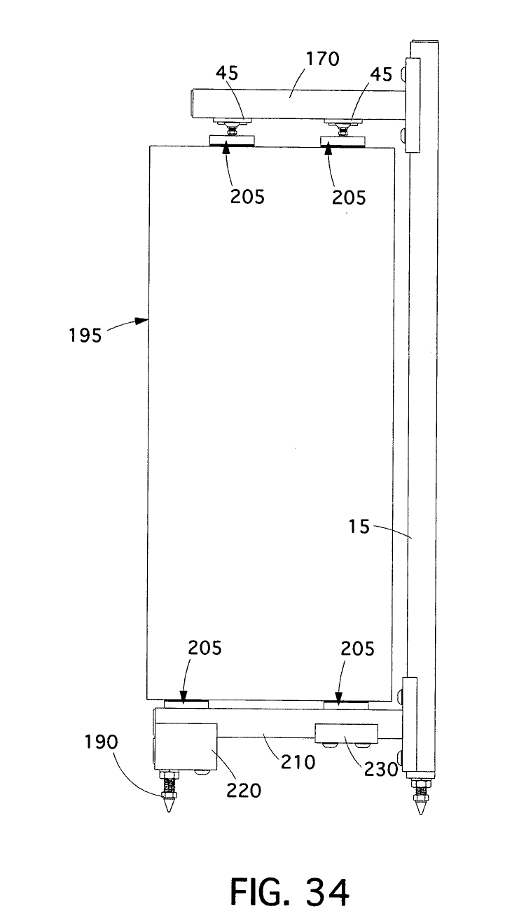

Referring to FIGS. 29-39, a fourth preferred embodiment of the invention is illustrated comprising a stand-alone loudspeaker stand 190. In general, the construction of the fourth preferred embodiment is similar to the third preferred embodiment 160 in that both utilize cantilever construction. They differ primarily in that the fourth preferred embodiment includes one or more upside down cross bar members 200 with the slot facing downwardly to receive an inverted mount to contact the top surface of the speaker. Further, the base members 210 and its associated cross bars 215 & 225 differ from the third preferred embodiment, although it is appreciated that the different base members and associated elements can be used interchangeably with either the third or the fourth preferred embodiments. Another difference is that the loudspeaker stand of the fourth preferred embodiment has only one support level since this stand is designed to support only a single speaker. The illustrated speaker stands, one for a small loudspeaker shown in FIGS. 29 & 30, and one for large load speakers shown in FIG. 34, are each about 44″ high, about 14″ wide, about 18″ deep concerning the elevated cantilever members 170 & 205, and about 20″ deep concerning the modified base members 210.

The speaker stand of the fourth preferred embodiment 190 is versatile and unique when compared to prior art speaker stands. Conventional prior art speaker stands typically consist of a floor-plate, or base, with a column or columns connected to a top plate (shelf) that is generally flat, and may contain mounting holes. A loudspeaker is supported by the top plate, to which it may or may not be secured via the mounting holes. Small loudspeakers, often called “monitors” or “bookshelf speakers”, must be elevated above the floor to approximately the height of a listener's ear, for optimum performance. Unlike large “floor-standing” speakers, small loudspeakers almost never have threaded connectors or leveling spikes on their bottoms.

Consequently, small loudspeakers simply rest on a conventional stand, or they may be loosely attached by the application of some tacky removable material in the form of a sheet or individual wads like chewing gum. These arrangements result in a precarious position for the loudspeaker, which can easily be knocked off the stand. As an alternative, if mounting holes are available, the loudspeaker may be secured to the conventional prior art stand with screws. This method solves the problem of attachment but requires, assuming the speaker does not come threaded connecters, holes to be drilled or otherwise made into the speaker. In some instances, holes drilled into the speaker case may functionally degrade speaker performance. Further, drilling holes into the speaker can void any manufactures warrantee, and negatively impact the re-sale value of the loudspeaker.

The speaker stand of the fourth preferred embodiment 190 not only solves the problem of secure attachment for a loudspeaker, but also provides a unique solution to other loudspeaker issues. Like no other stand, the fourth preferred embodiment functions like a large c-clamp that effectively locks the loudspeaker 195, top and bottom, between vertically opposed mounts 205. The (adjustable) pressure applied to the speaker cabinet by the mounts 205 increases the cabinet's rigidity and decreases harmful cabinet resonance. And depending on the type of mounts used, the mounts 205 can absorb harmful cabinet vibrations, and provide isolation from external vibrations to enhance the speaker's performance.

Referring back to FIG. 29, the upside down cross bar 200 is in all respects similar to the standard cross bar 35 except that the slotted side of the channel element is facing downwardly permitting a mount 205 to be faced facing downwardly as well. The mounts illustrated in the Figures associated with the fourth preferred embodiment are simple platform mounts 205 with a layer of viscoelastic material adhesively bonded to their top surfaces. The mounts act primarily to couple a loudspeaker to the rack but also provide damping by way of the viscoelastic layer as is described in greater detail in the following section. It is to be appreciated that any of the mounts described in the following section of this specification can be used in the various preferred embodiments of the rack system, as well as, alternative embodiments thereof. Further, the different types of mounts can be used with any rack system.

As mentioned above, the base members 210 and the associated cross bar channel elements vary from the third preferred embodiment. As individually illustrated in FIG. 38, the modified base member of the fourth preferred embodiment comprises (1) a mounting bracket 180 similar to that of the base member 165 of the third preferred embodiment; (2) a first channel element with a downwardly facing slotted side that is welded to the mounting bracket at a back end and extends outwardly therefrom; (3) a second much shorter piece of channel element that is welded to the slotted side of the first channel element with its front end flush with the front end of the first channel element and it slotted side facing downwardly; and (4) end caps 175 welded to each of the front ends of the first and second channel elements.

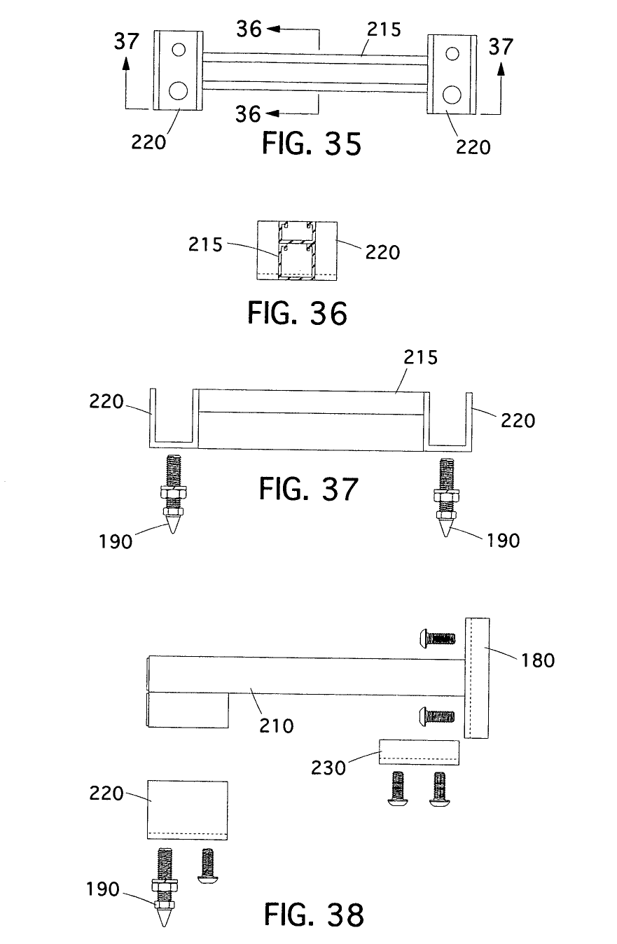

A first modified cross bar member 215 is illustrated in FIGS. 35-37 and comprises two deep U-shaped end fittings/mounting brackets 220 that are welded on either end of a pair of stacked and welded channel elements. The top element has its slot 55 facing upwardly to receive a mount 205 as shown in FIG. 34. The deep U-shaped end fittings fit over the ends of the modified base members 210 and are attached thereto via a cap screw 60 passing through a first bore in the base of the U-shaped fitting and a channel nut 80 received in the slot 55 of the second channel element. A second threaded bore is provided in the base of the U-shaped end fitting through which a spike assembly 190 is received to support the front end of the speaker stand. The use of the stacked channel element modified cross bar results in a stiffer base section that more securely supports the speaker and acts to increase the resonance frequencies of the stand itself.

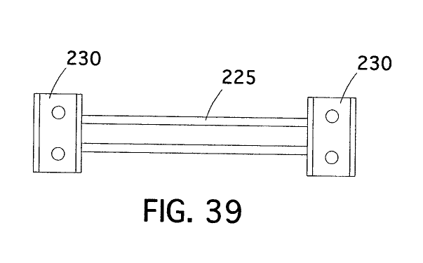

A second modified cross bar member 225 is illustrated individually in FIG. 39. It is generally similar to the standard cross bar members 35 described above except it has an end fitting 230 that is both U-shaped and longer than the L-shaped end fittings 45 of the standard cross bar member 35. Further, the base of the U-shaped fitting has two bores for receiving two cap screws 60 therethrough so that each fitting of the second modified cross bar can be secured to a modified base member 210 by two cap screws and two associated channel nuts 80. By using a longer U-shaped end fitting and two cap screws, the second modified cross bar member also acts to significantly stiffen the base section structure, thereby increasing the resonance frequency thereof.

As can be appreciated, given the diverse configurations of the four preferred embodiments of the rack system, a large number of variations and alternative embodiments of the rack system are possible using the building channel elements described and illustrated herein or other elements that would be obvious to one or ordinary skill in the art given the benefit of this disclosure. Broadly, the present invention related to the rack system is intended to embody any rack for audio/video components using strut channel significantly in its construction. More specifically, the invention concerning the rack system relates to a rack made of strut channel that supports one or more components without the use of a shelf. In place of shelves, mounts that are directly attached to the strut channel elements to support the components. It is to be appreciated that alternative embodiments may have one or more shelves, such as the one provided in the second preferred embodiment. Also in other alternative embodiments shelves, can be provided that rest upon the mounts themselves. Even more specifically, the invention concerning the rack system comprises a rack made with strut channel having vertical columns connected with horizontal members, wherein the horizontal members have mounts attached thereto to support components.

The Mounts

As mentioned above, mounts are typically used as the interface between the rack structure and an audio/video component. Typically, the mounts include threaded studs 87 to interface with a channel nut 80 to secure the mount into the slot 55 of a cross bar member 35, but in alternative embodiments mounts with alternative exterior configurations and surfaces are contemplated to permit the mount to be used in a traditional prior art rack system as an interface between a shelf and the component. Further, in other variations the mounts alone or in conjunction with suitable adapters can be used to support a rack structure by taking the place of the floor spikes to provide the associated rack system with an additional degree of damping and isolation from the floor-borne vibration.

In general, there are four types of mounts: (1) simple platform mounts that act to merely couple the component with the rack system and provide no appreciable damping or dissipation of vibrational energy, but rather provide a superior path for any vibrational energy generated in the component to drain out of the component, pass through the rack and into the floor; (2) bearing mounts that utilize a ball bearing in at least one race to isolate lateral (or horizontal) vibration between the component and the rack structure; (3) damping mounts that incorporate a layer of viscoelastic material that is typically constrained to absorb vibration and convert it to low grade heat through the process of hysteresis; and (4) hybrid mounts incorporating one or more viscoelastic layers and a ball bearing in at least one race. Any of these types of mounts can be utilized with the rack systems described above depending on the level of damping, isolation and vibrational energy drainage desired by a user. Further, different types of mounts can be utilized on the same rack structure. For example, a turntable may be supported by bearing mounts while a receiver on the same rack may be supported by damping mounts.

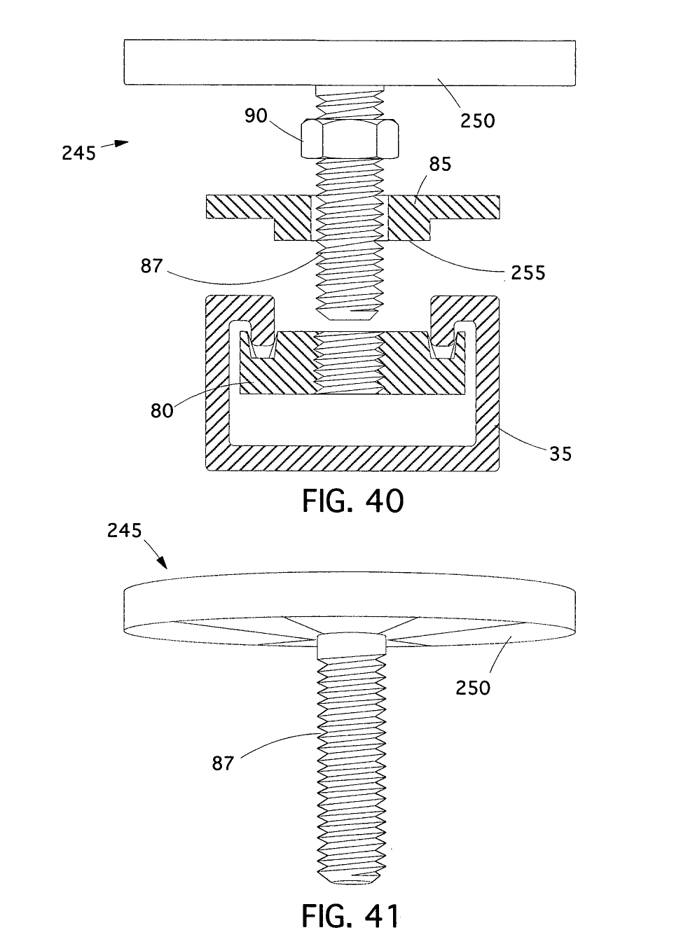

Referring to FIGS. 40-45 several embodiments of simple platform mounts are illustrated. In its simplest form, the platform mount 245 comprises a threaded stud 87 having a simple disc platform 250 generally with a flat top surface at one end as shown in FIGS. 40 and 41. For use with the preferred embodiments of the rack systems described above, a ⅜″16 sized stud is utilized, although others may be used in other embodiments. The disc of this mount and the others all have outside diameters of about 2½″, but the diameter can vary in alternative embodiments. The disc can be fabricated separately from the stud with a bore extending inwardly from the center of the bottom surface to receive the stud therein, or the entire mount can be machined, cast or forged unitarily. The disc is typically comprised of steel or aluminum, but other materials can be utilized as well.

Referring to FIG. 40, to secure any mount to a strut channel, a lock nut 90 is first threaded onto the stud 87 of a mount. Next, a bearing mount washer 85 is slipped over the end of the stud. A typical bearing mount washer includes a thicker center portion 255 having diameter just slightly less than the width of an associated slot 55 so that it can be received therein. The diameter of the washer as a whole is generally similar to the width of the slotted side of the channel element, such that the washer is braced against the top surface of the slotted side. A channel nut 80 of dimensions corresponding to the particular channel element of the rack is placed through the slot and orientated in the slot such that its slots 95 are aligned with the inturned edges 75 of the channel element, and the end of the stud is threaded through the bore 105 in the nut. The user adjusts the height of the mount by threading more or less of the stud into the channel nut and when the desired height is achieved, and the user secures the mount in place by tightening the lock nut against the bearing mount washer to pull the slots of the channel nut against the inturned edges of the channel element.

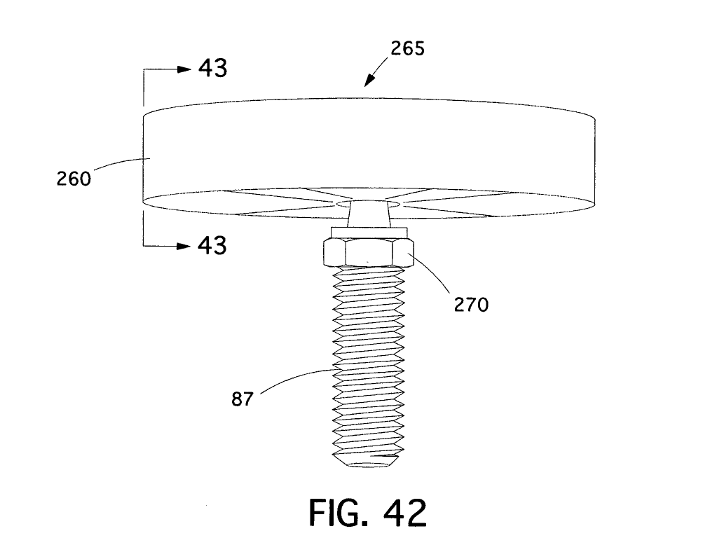

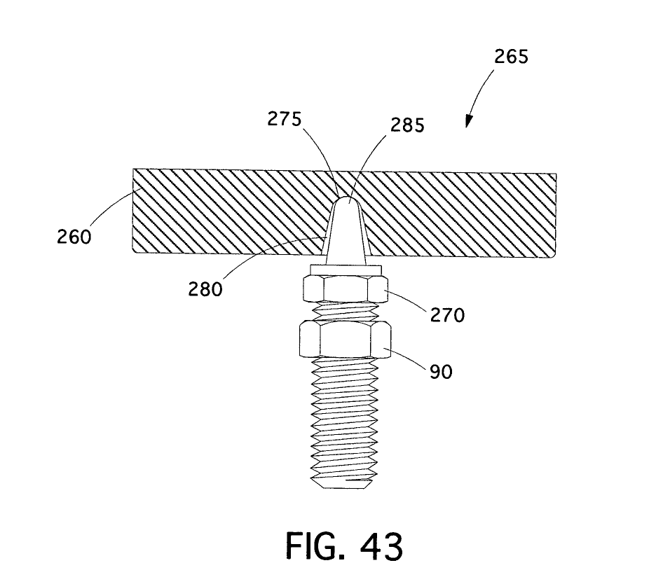

Referring to FIGS. 42 and 43, a first self adjusting simple support type mount 265 is illustrated wherein a disc 260 essentially floats on the hemispherical tip 285 of an associated mount spike 270 which engages the slightly larger hemispherical terminus 275 of a counter-bore 280 in the center of the bottom side of the disc. As shown, the mount spike is threaded over the end of the stud 87 although in other embodiments the spike can be integrally formed in the end of a stud. The reduced area of contact at the interface of the terminus of the bore and the top of the spike discourages the passage of harmful vibrations from the rack to the disc and into the components it supports, thus providing a degree of component isolation. In addition, because the disc 29 can pivot off of horizontal by several degrees, the disc can self-align with the chassis of the component when the bottom side of the chassis is uneven or not planar, thereby ensuring proper contact with the component.

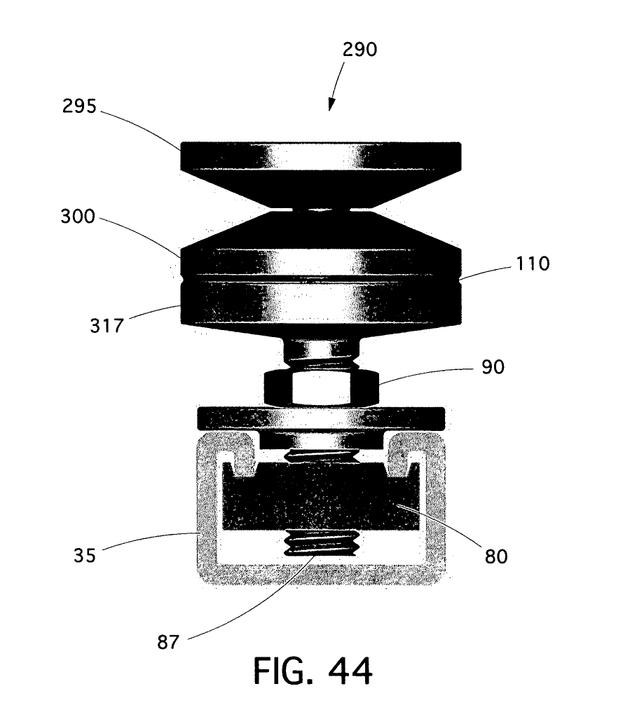

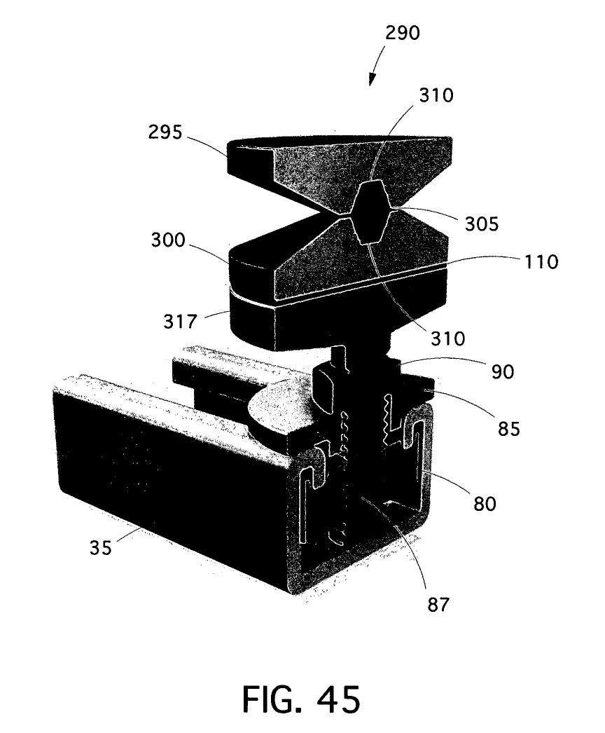

Referring to FIGS. 44 & 45 another self-adjusting mount 290 is illustrated. As illustrated, the mount includes a constrained layer of viscoelastic material 110 to damp vibrations; however, this mount is also configurable as a simple mount without a constrained layer. The preferred variation of the second self-adjusting mount comprises top and bottom anodized aluminum 6061 alloy discs 295 & 300 which are coupled by a single ⅜″ tungsten carbide ball 305, which fits into only slightly larger counter-bores 310 in each disc. The aluminum and tungsten carbide materials enhance the performance of the mount due to their excellent transmissibility which facilitates the expeditious flow of vibratory energy. Typically, the ball does not roll or move laterally or vertically in the bores, but it permits the upper disc to pivot from the horizontal by several degrees, which like the first self adjusting mount 265 helps ensure full contact of the upper disc 295 with an uneven or irregular component chassis bottom. The 3-piece, disc-ball-disc stacked and nested relationship creates a very stable mount that because of the depth of the counter-bores, the possibility of disengagement of the top disc from the rest of the mount due to accidental lateral forces impacting the component is significantly reduced. As shown, the bottom disc 300 is bonded to a viscoelastic layer, which in turn is bonded to a base disc 317 that includes a stud 87 that attaches to the rack structure as discussed above. In variations without the constrained layer the base disc 317 and the bottom disc 300 are integral to each other. The preferred variation of the second self-adjusting mount has a diameter of about 1.8″, although other diameter can be used.

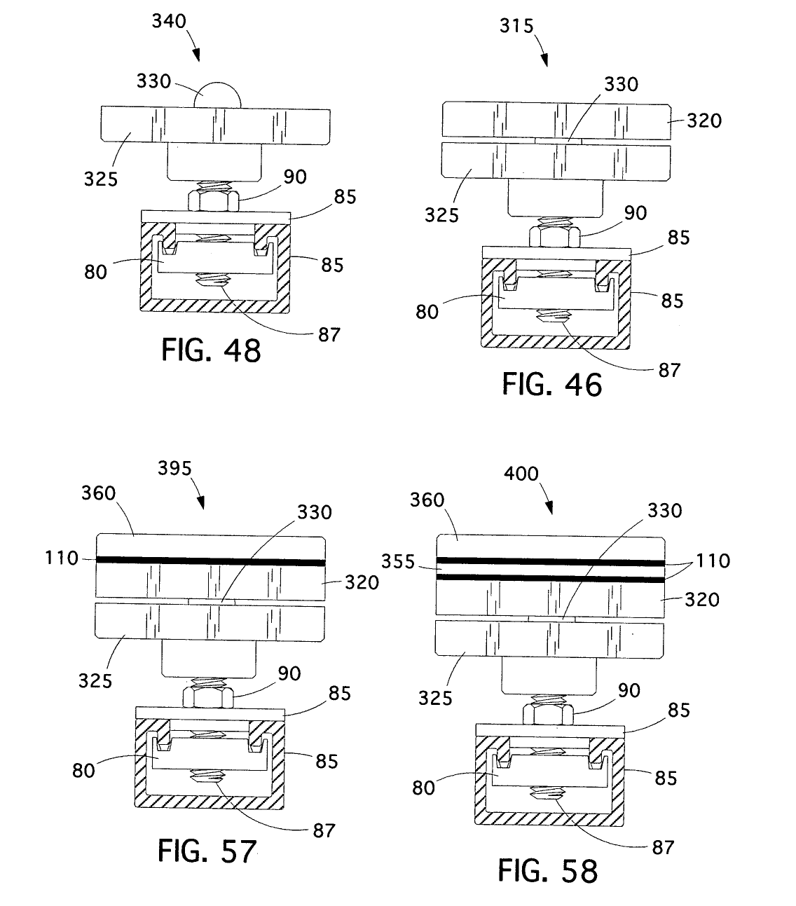

Referring to FIGS. 46-52 several embodiments of bearing mounts are illustrated. In general, bearing mounts incorporate a ball bearing 330 that provides isolation and damping of laterally directed vibrational energy. FIG. 46 is an illustration of a typical dual race bearing mount 315 incorporating top and bottom discs 320 & 325 with bearing races and a ball bearing sandwiched therebetween. Preferred embodiments of the bearing mounts are about 1.8″ in diameter. FIG. 47 shows an “exploded view” of a typical bearing assembly. The bearing assembly comprises of the two vertically opposed top and bottom bearing-discs 320 & 325 and a ball bearing 330. Each disc includes a semi-spherical indented race 335 in which the ball bearing is retained that faces an opposing semi-spherical indented race 335 of the other disc. The effective radius of the semi-spherical indented races are significantly larger than the radius of the ball bearing, allowing the ball bearing to move laterally in any direction from the nominal center of the discs and the races. Vibrational energy emanating from a component, which is directed laterally, will cause the ball bearing to move along the contour of the semi-spherical indented races, thereby moving vertically upwardly against the weight of the component and dissipating a significant portion of the vibrational energy as work. Further, dissipation occurs by re-directing the vector of the lateral vibrational energy vertically where it is drained through the bottom disc 325, through the stud 87 and the rack structure, and into the floor. As the ball moves in the races, the bearing maintains a continuous flow of vibrational energy. Alternately, laterally directed vibratory energy emanating from the floor and the air, which passes into a rack or loudspeaker, will result in the same ball movement and energy dissipation.

In addition, because the top disc can pivot relative to horizontal, a bearing mount effectively self-aligns (or self adjusts) with the bottom of the chassis of a component adjusting for topography differences and ensuring proper contact.

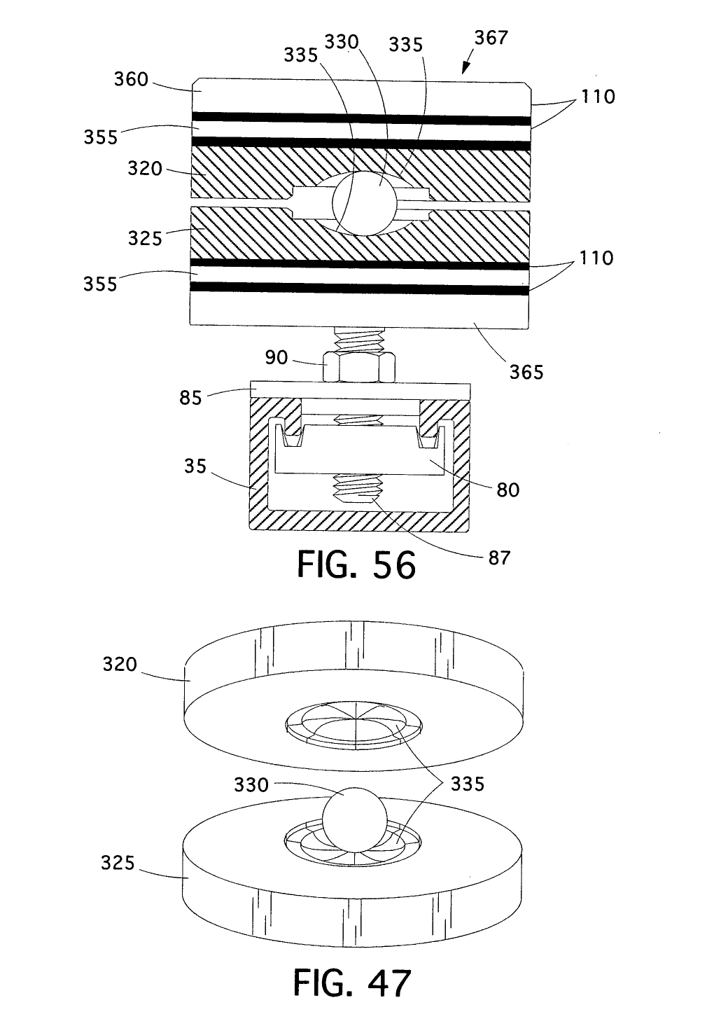

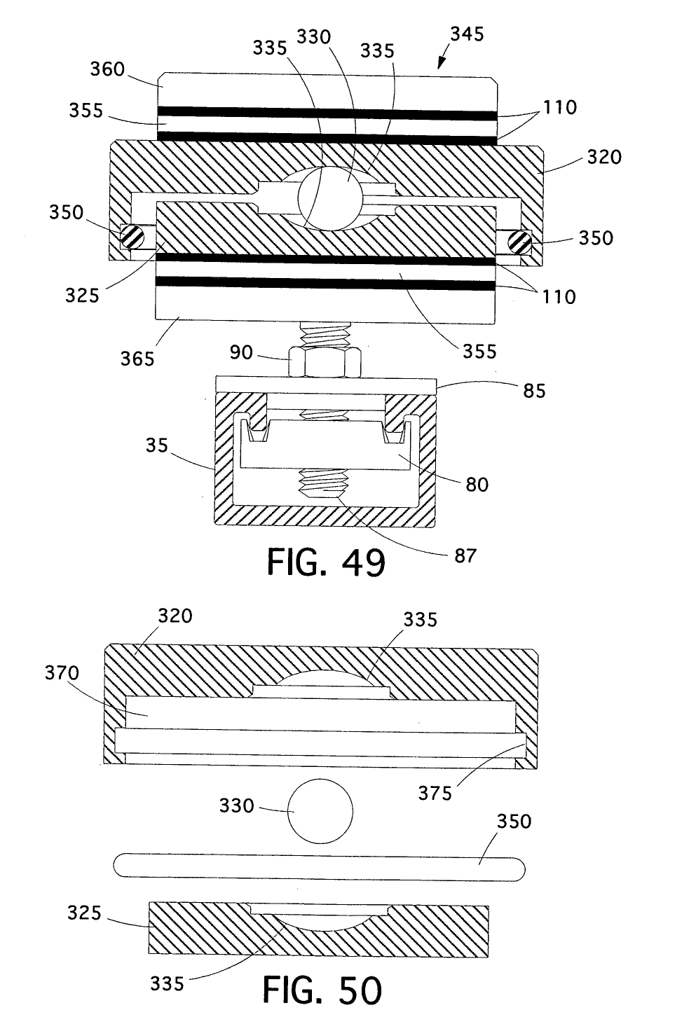

Referring to FIG. 48, a bearing mount 340 having only a bottom disc 325 in which the ball bearing is received is illustrated. The exposed bearing 330 is placed directly against the bottom of a component and this mount performs essentially the same lateral isolation and damping functions as the two disc bearing mounts albeit generally not as effectively. Referring to FIGS. 49-52, two versions of bearing mounts 345 & 347 incorporating resilient O-ring rings 350 to limit the maximum lateral travel of a top disc 320 (or disc stack) relative to the bottom disc 325 are illustrated. Referring specifically to FIGS. 49 & 50, the top disc of the first version of the O-ring bearing mount has a larger diameter than the bottom disc, and includes a large bore 370 on its bottom side that also has a diameter significantly greater than that of the bottom disc such that the bottom disc can be at least partially received into the large bore. The semi-spherical indented race 335 for the ball bearing on the top disc is formed into the center of the large bore's end surface. Further, an annular channel 375 is provided along the side surface of the large bore that is sized to receive an O-ring 350 therein. Because of the overlap of the top and bottom discs limits the movement of the top disc, the potential for separation of the mount 345 from an accidental impact with the component that is set upon the mount is reduced. And in addition, the ball is unlikely to roll out of the races and impact the aluminum discs, which could possibly cause abraded particles to enter the race and impede the free movement of the ball. Moreover, because the upper disc “overhangs” the lower disc, the gap between them is not straight through to the race and ball. Instead, the gap is “broken” by a right angle which significantly discourages the entry of air-born contaminants that could impede the free movement of the ball.

The O-ring acts to damp and absorb the forces of such an impact and prevents metal-to-metal contact of the discs. In contrast, an impact of a relatively low force to the bearing mount 315 of FIG. 46 could cause the top disc to move a sufficient distance such that the ball bearing 330 essentially rolls out of the top disc's race 335 freeing the top disc 320 to roll off of the bearing altogether, thereby separating the mount.

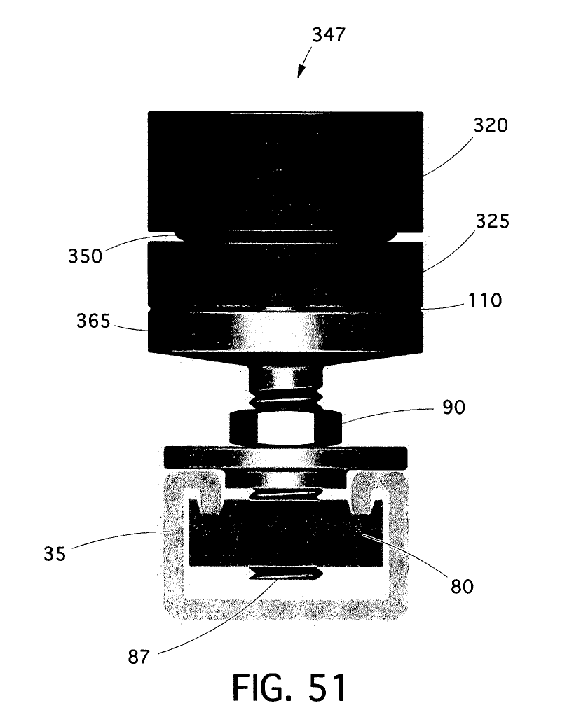

FIGS. 51 & 52 illustrate a second version 347 of the O-ring bearing mount. In this version the diameter of the top and bottom discs 320 & 325 are similar. The top disc has a large bore 370 in it generally similar to the large bore described concerning the first version; however the diameter of the bore is less than the diameter of the bottom disc preventing the bottom disc from being at least partially received therein. The bottom disc includes a ridge 377 that rises from the top surface of the disc and surrounds the associated bearing race 380. The height of the ridge is less than the depth of the large bore and accordingly, the ridge is received into the large bore when the mount is assembled. An O-ring 350 is provided that is placed around the outside of the ridge. Accordingly, when the top disc is moved too far (over 3/32″ in preferred embodiments of the second version O-ring bearing mount), the side surface of the large bore contacts the O-ring and prevents the separation of the top disc from the rest of the bearing mount. As in the first version of the bearing mount, the ball is unlikely to roll out of the races and impact the aluminum discs, which could possibly cause abraded particles to enter the race and impede the free movement of the ball. It is further appreciated that because the upper disc “overhangs” the lower disc, the gap between them is not straight through to the races and ball. Instead, the gap is “broken” by a right angle which significantly discourages the entry of air-born contaminants that could impede the free movement of the ball.

Another feature of the second version of the O-ring bearing mount is the inclusion of tungsten Carbide races 380 and a Tungsten carbide grade 5 ball bearing 330 as best shown in FIG. 52. The races are finished to a level of better than 5-microinches. Tungsten Carbide is utilized in the races and ball bearings of the preferred embodiments of the bearing mounts because of its extraordinarily high modulus of elasticity, hardness, toughness, and vibration transmissibility. Tungsten Carbide has exceptional resistance to abrasion, galling, fretting, and surface “micro-welding”, and it exhibits a very low dry coefficient of friction as compared to steels. These properties all effect the performance of dry bearing systems, such as used in the bearing mounts, as well as, provide both increased load capacity and greater bearing longevity. In general, even the best heat-treated bearing steels are grossly inferior to Tungsten Carbide in this type bearing application. The discs are typically fabricated of a 7075 aluminum alloy because of the material's superb transmissibility properties, high strength, and ability to be hard-coat anodized to an attractive and durable finish.

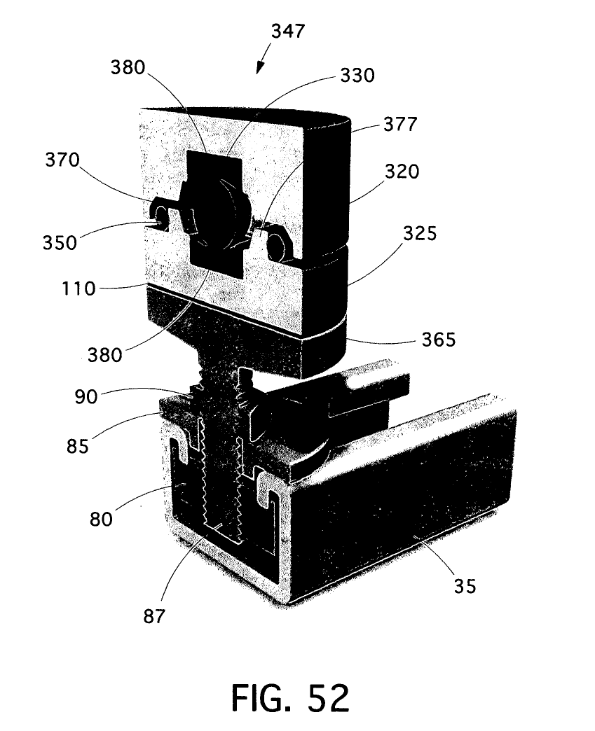

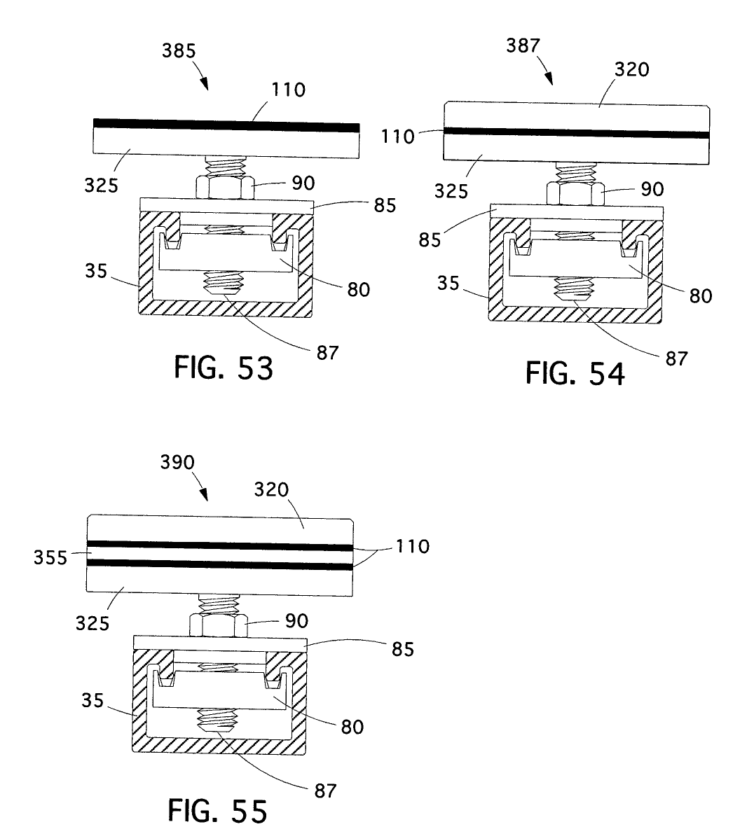

Referring to FIGS. 53-55 several embodiments of damping mounts are illustrated. Damping mounts typically comprise a constrained layer of a viscoelastic material 110 of the type described above in reference to the variations of the cross bar members 35 having a constrained layer of viscoelastic material. Operationally, as the viscoelastic material is subject to 1 vibration either from the rack or the component, the constrained material deforms in partially a fluid manner and partially an elastic manner. The important consideration concerning this deformation is that it absorbs a significant portion of the vibration and transforms the energy into heat. Accordingly, a significant portion of any vibrational energy being propagated through the rack will not be transmitted through the damping mount to the component and vice versa. Effectively, the constrained viscoelastic layer at least partially isolates the component from the rack structure.

FIG. 53 illustrates a mount 385 very similar to the mount of FIGS. 40 & 41 except an unconstrained layer of viscoelastic material 110 is adhesively bonded to the top surface of this mount. It is appreciated that the viscoelastic layer in this form is not constrained and would provide only minimal damping capability. However, when the mount is used with the fourth preferred embodiment to effectively clamp a speaker in place, a constrained layer is essentially created wherein the viscoelastic material can absorb vibrational energy.

FIG. 54 illustrates another mount 387 that is similar to the mount 385 of FIGS. 53, except in addition to the viscoelastic layer, this mount also includes a top disk 320 that is bonded to the top surface of the viscoelastic layer 110 to effectively constrain it. In many instances, this mount will be more effective than the mount of FIG. 53 because the viscoelastic layers performance is not at all dependant on the manner in which it is constrained by the component it is damping.

FIG. 55 illustrates yet another mount 390 that is similar to the mount 387 of FIG. 54, except two layers of viscoelastic material 110 are sandwiched between three discs: a bottom disc 325; an intermediate disc 355; and a top disc 320. This mount behaves similarly to the mount of FIG. 54 except that the second viscoelastic layer will act to absorb vibrational energy that is not absorbed by the first viscoelastic layer it passes through. Accordingly, this mount more effectively isolates a component from the rack structure.

Although the damping mounts of FIGS. 53-55 are all derivative of the simple platform mount 245, in alternative variations, the mounts based on the first self adjusting mount 265 of FIGS. 42 and 43 can be made. Further, the second self-adjusting mount 295 of FIGS. 44 and 45 is illustrated with a constrained viscoelastic-damping layer 110. In fact, as will be come more apparent when viewing the various ball bearing mounts illustrated in FIGS. 56-63, viscoelastic layers can be incorporated into the mounts in a wide variety of configurations in conjunction with other vibration control features. These hybrid combinations of mount technology offers to more effectively isolate a component and a rack. Concerning the hybrid mounts, a wide variety of combinations of ball bearings, races, and constrained viscoelastic layers are possible as would be obvious to one of ordinary skill in the art given the benefit of this disclosure.

Referring specifically to FIG. 56, the general operation of a preferred embodiment hybrid bearing mount 367 incorporating several constrained layers of viscoelastic material 110 is described. Vibrational energy emanating from a component or loudspeaker that is directed vertically travels downwardly through an interface disc 360 into the first viscoelastic material layer 110 where a more significant portion of the energy is converted to low-grade heat and dissipated. Any remaining energy that is not absorbed by the first viscoelastic material 110 passes into an upper intermediate constraining disc 355 where a small portion thereof is dissipated by internal damping. Finally, a second layer of viscoelastic material 110 is provided to complete the dissipation of vertically-directed vibrational energy. Vibrational energy emanating from the rack that is directed vertically, travels upwardly and is dissipated by the viscoelastic material layers 110 in a similar manner as described above for vertically-directed vibrational energy emanating from the component. Laterally-directed vibrational energy is also absorbed by the viscoelastic damping layers 110, but any remaining laterally-directed energy that is incident on the ball bearings 330 and the races 335 is either or both dissipated as work or transformed into vertically directed energy that is damped by the viscoelastic layers 110. It is appreciated that by utilizing a mount 367, such as illustrated in FIG. 56 or similar mounts incorporating both a bearing assembly and one or more layers of constrained viscoelastic material, that a component or loud speaker is effectively isolated relative to the rack and its surroundings insofar as vibrational energy is concerned. Only insignificant levels of vibration can be passed through the mounts, thereby ensuring the maximum performance of the supported component or loudspeaker.

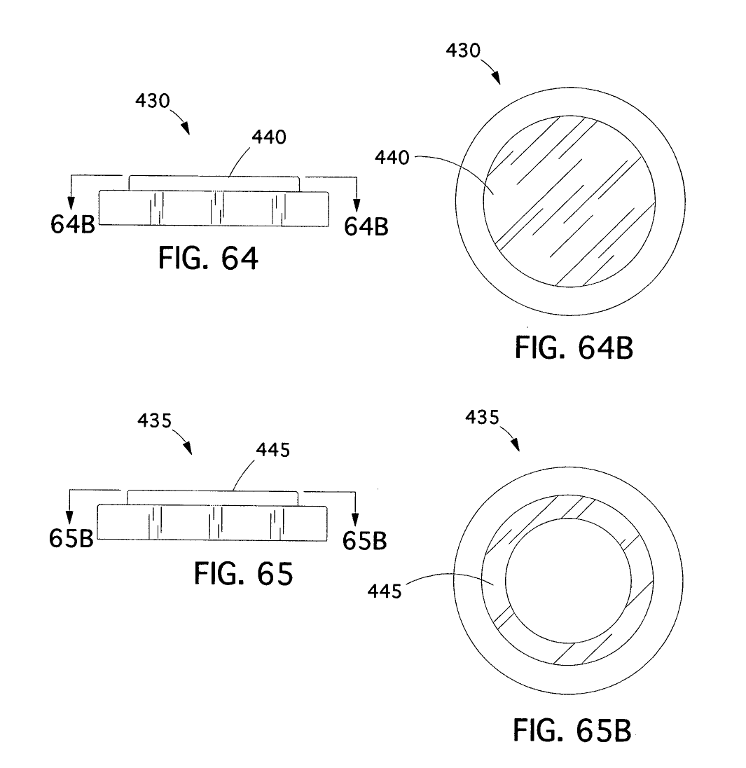

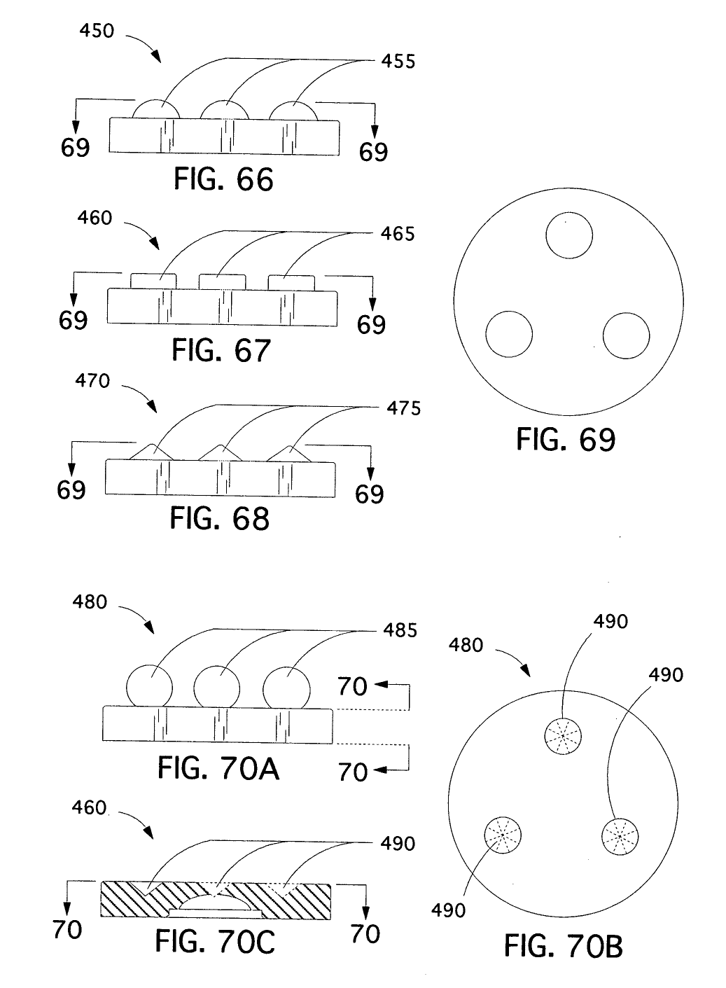

Concerning the mounts illustrated heretofore, they all have top interface surfaces that are substantially flat and planar for coupling with the bottom side of a component or loudspeaker. It is appreciated, however, that any number of interface surface variations may be provided for almost any of the mounts described herein and obvious alternative embodiments thereof. Some alternative examples include: a raised flat interface surface 430 with a flat circular protrusion 440 as shown in FIGS. 64A and 64B; an interface surface 435 with a ring-shaped protrusion 445 as shown in FIGS. 65A and 65B; an interface surface 450 with hemispherical protrusions 455 as shown in FIG. 66; an interface surface 460 with round columnar protrusions 465 as shown in FIG. 67; an interface surface 470 with (small) conical protrusions 475 as shown in FIG. 68. FIG. 69 represents a top view common to the profiles of FIGS. 66-68. Additionally, two interface surfaces 480 & 495 comprising one or more conical counter-bores 490 & 493 are depicted in FIGS. 70A-C and 71A-C respectively and include non-moving balls 485 & 497 set in the counter-bores.

Mounts with other than flat interface surfaces provide solutions for coupling to components that have irregular bottom surfaces, perforations, and protruding connectors. A mount that has a flat interface surface requires a flat surface of the same area for proper coupling. And, the component must have three or four flat surface areas that occur in positions that permit proper mount spacing. However, a mount having an interface surface of any of the illustrated profiles benefits from a reduced contact area between the component and the mounts. With reduced or minimal contact area, a mount can bridge surface irregularities and perforations and avoid protruding connectors to insure proper coupling.

Another important benefit is derived from having a choice of interface surface profiles. Because the shape and size of the mount, the contact area can affect the performance of the mount. This phenomenon is largely component dependant and may be subjective. One component or loudspeaker may sound better to one person with a certain mount and interface surface while sounding worse to others. The choice of surfaces therefore permits a particular user to tailor a rack system to provide the performance characteristics that he/she prefers.

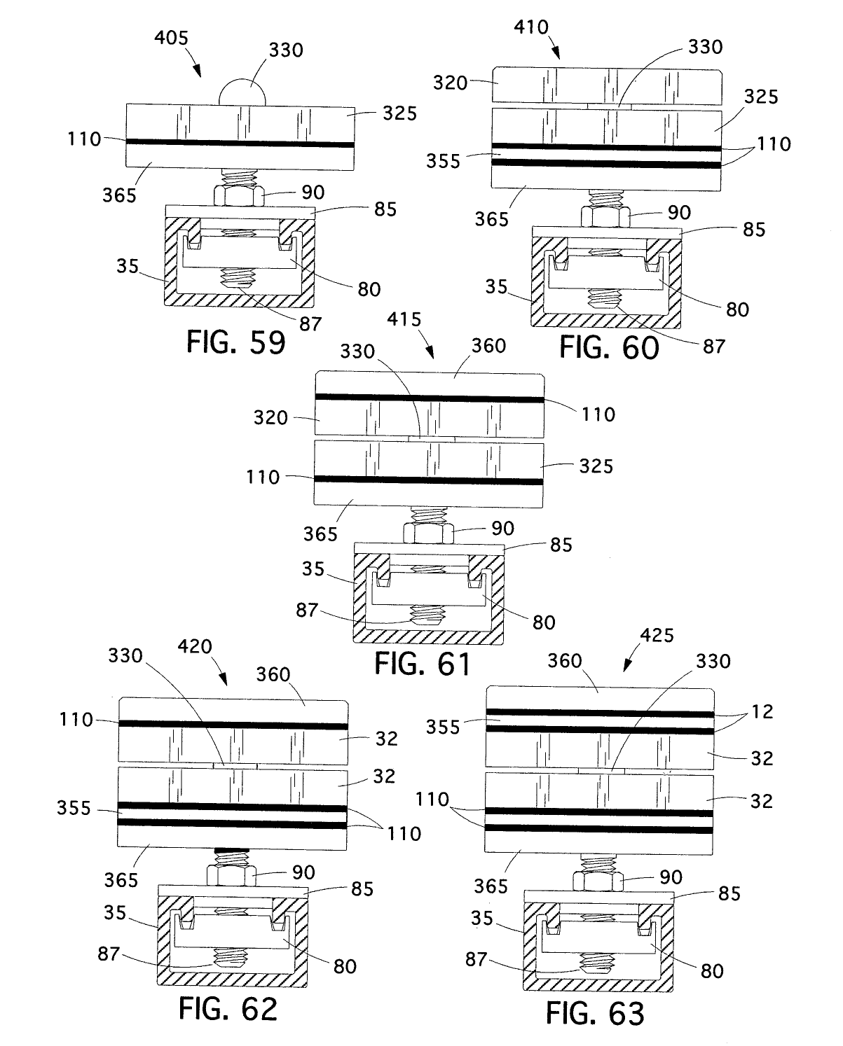

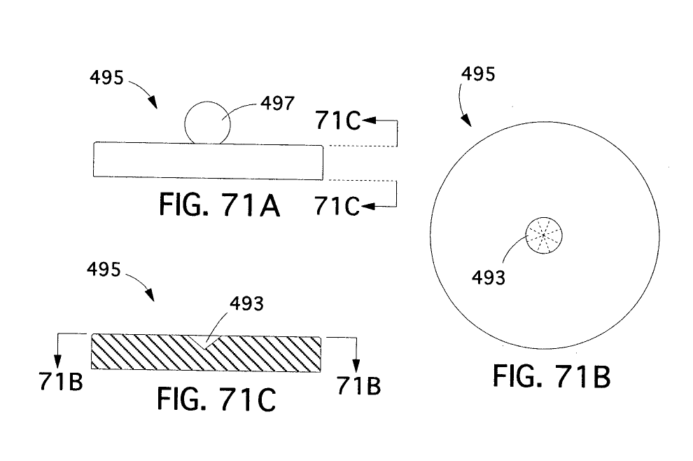

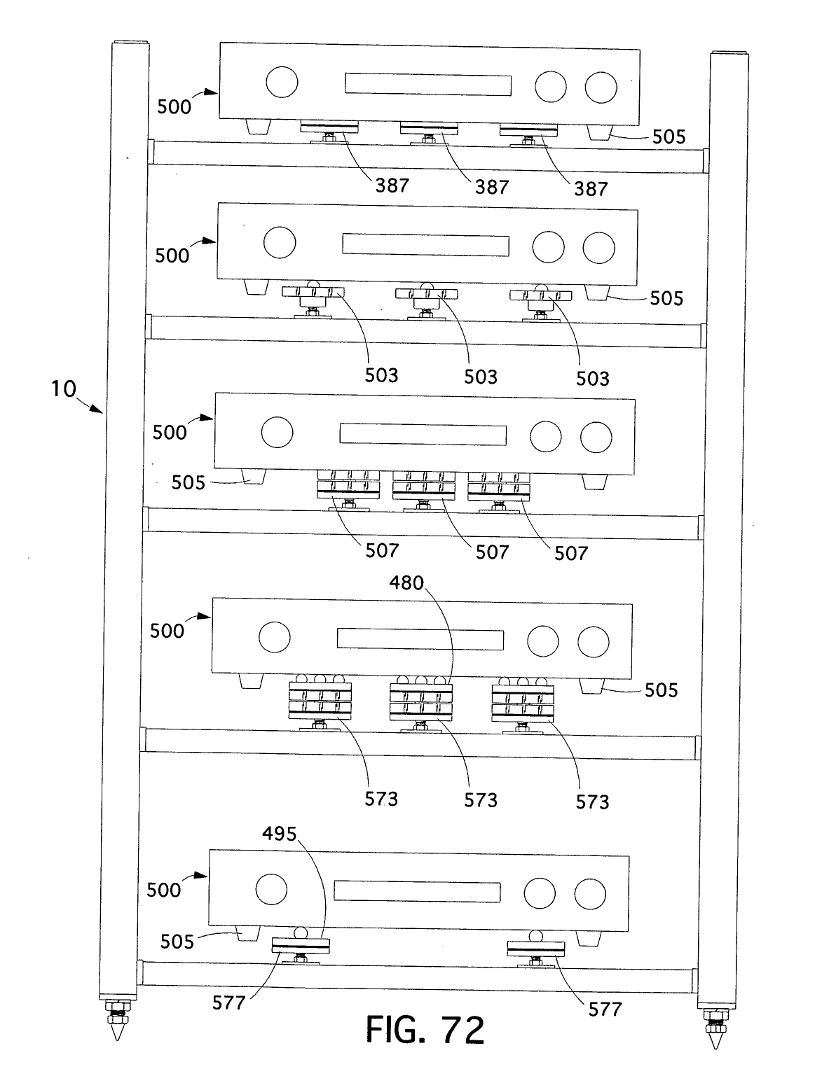

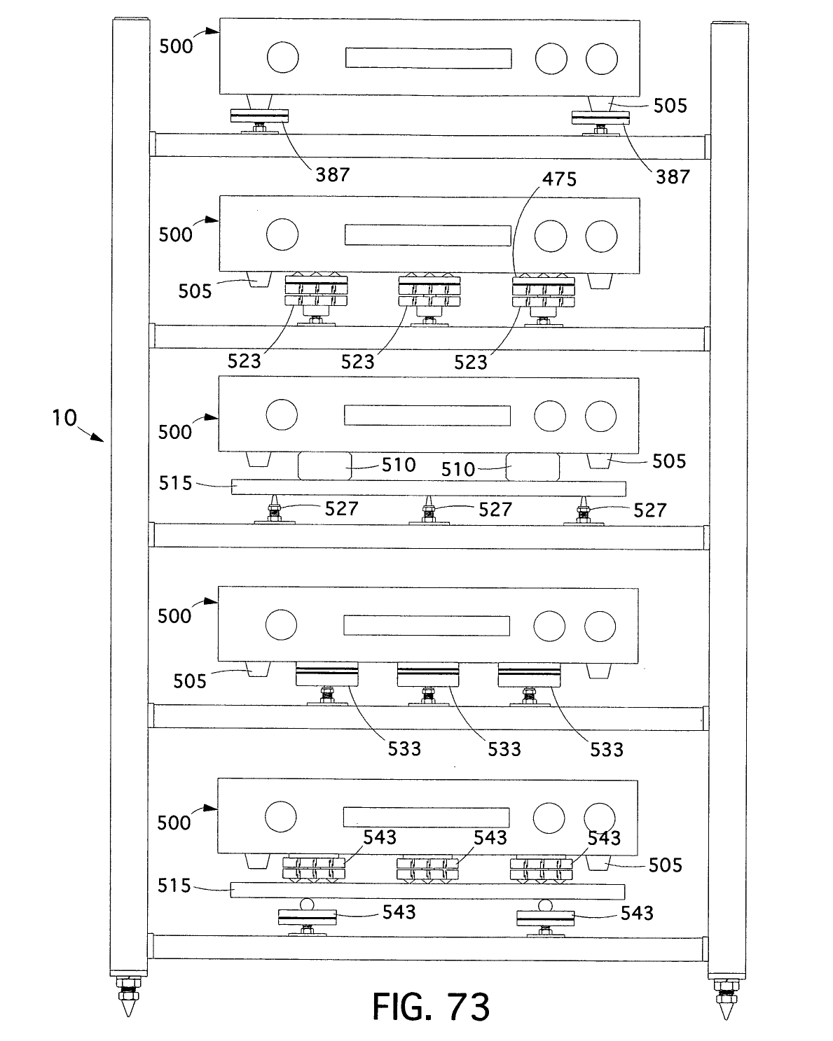

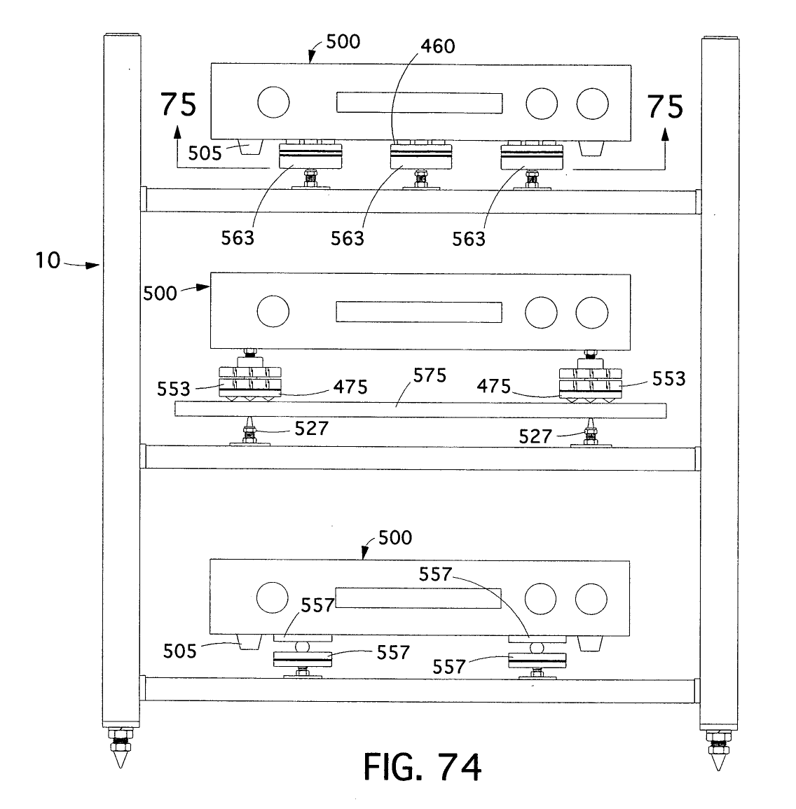

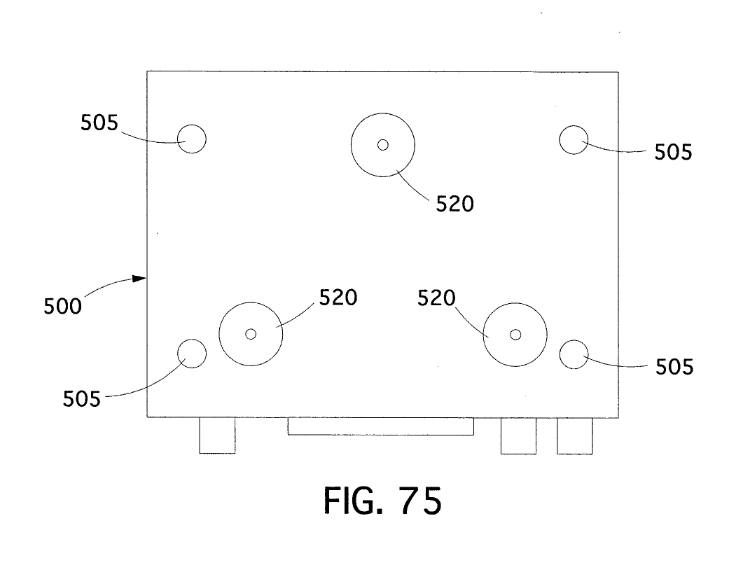

Referring to FIGS. 72-74, multilevel rack structures 10 are illustrated with a component 500 on each level. Different types of mounts or different configurations support each component. The typical configuration and locations 520 used to support a component via mounts and raise the component off of its stock feet 505 is illustrated in FIG. 75, although in variations four mounts can be used instead of three. It is appreciated that additional variations are possible as would be obvious to one of ordinary skill in the art with the benefit of this disclosure. Specifically referring to FIG. 72: (1) the top layer shows a component support by the mounts 387 of FIG. 54; (2) the second layer shows a component support by mounts 503 similar to the mounts 405 of FIG. 59; (3) the third layer shows a component support by mounts 507 roughly similar to the mounts 410 of FIG. 60; (4) the fourth layer shows a component support by mounts 513 roughly similar to the mounts 367 of FIG. 56 including the interface surface 480 of FIGS. 70A-C; and (5) the fifth layer shows a component supported by mounts 517 roughly similar to the mounts 387 of FIG. 54 including the interface surface 495 of FIGS. 71A-C. Specifically referring to FIG. 73: (1) the top layer shows a component supported at its feet by the mounts 387 of FIG. 54; (2) the second layer shows a component support by mounts 523 roughly similar to the mounts 410 of FIG. 60 including the interface surface 475 of FIG. 68; (3) the third layer shows a shelf 515support by spiked mounts 527 roughly similar to the spiked feet assembly 185 shown in FIG. 30 with the component supported on the shelf by resilient blocks 510; (4) the fourth layer shows a component support by mounts 533 similar to the mounts 390 of FIG. 55 in combination with the mounts 265 of FIG. 42; and (5) the fifth layer shows a shelf 515 supported by mounts 537 roughly similar to the mounts 387 of FIG. 54 including the interface surface 495 of FIGS. 71A-C, wherein the component is supported by a studless bearing mount 543. Specifically referring to FIG. 74: (1) the top layer shows a component 500 supported by mounts 563 roughly similar to the mounts 390 of FIG. 55 including the interface surface 460 of FIG. 67; (2) the second layer shows a shelf 515 support by spiked mounts 527 with a component on the shelf supported by upside-down bearing mounts 553 similar to those of FIG. 57 including the interface surface 475 of FIG. 68 facing downwardly (this configuration is applicable only to components with threaded bottoms); and (3) the third layer shows a component supported by mounts 557 roughly similar to roughly similar to the mounts 387 of FIG. 54 including the interface surface 495 of FIGS. 71A-C with an additional plate or disc 557 between the component and the mount.

Up to this point, all the mounts described have included a stud 87 so that the mount can be secured to the rack system embodiments described above. It is to be appreciated that the mounts can be produced in almost all the described variations with flat or profiled interface surfaces on both the top and the bottom of the mounts. Accordingly, studless mounts can be used in conjunction with prior art rack systems that utilize shelving.

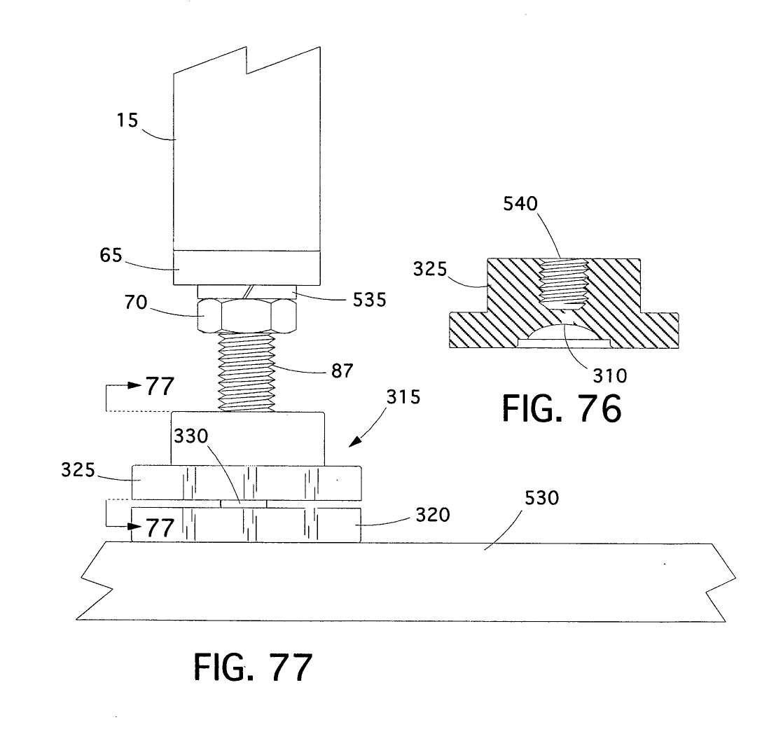

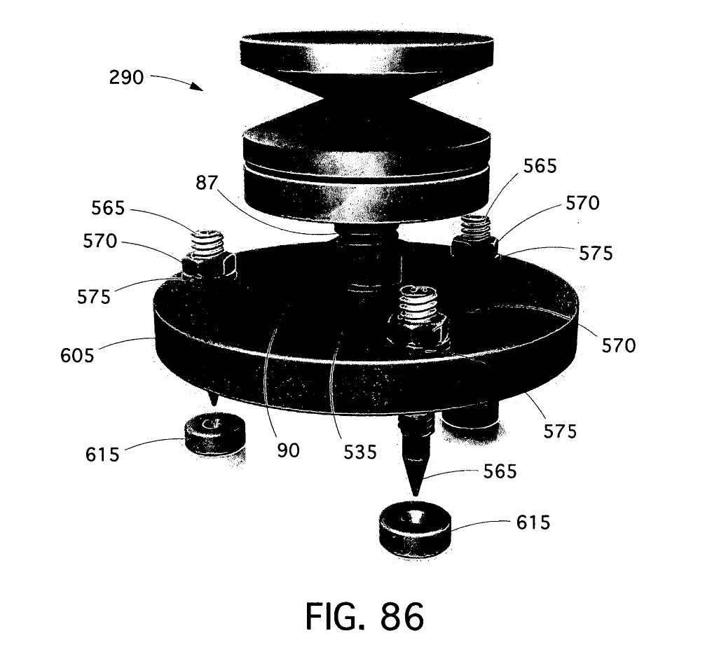

The mounts have also been described herein primarily for the purpose of supporting components 500 on a rack system. However, the mounts can be utilized in various configurations for supporting a rack or a loudspeaker on a floor or other ground surface as illustrated in FIGS. 76-86. For instance, an upside down bearing mount, such as the bearing mount 315 illustrated in FIG. 46, can be used to support the columns 15 of a rack on a hard and substantially flat surface such as a floor 530 as shown in FIG. 76. The stud 87 is threaded into the threaded weld nut 65 at the end of a column 15 and is secured in place with a lock nut 70 and a lock washer 535. Referring to FIG. 77, a cross section of the bottom disk 325 of the bearing mount 315 is shown. As discussed previously, the stud can be integrated into the bottom disk of a bearing mount or it can be threaded into a bore 540 in the bottom disc as shown here. It is appreciated that the height of the mounts can be adjusted in the same manner as the adjustable floor spikes 25 they replace.

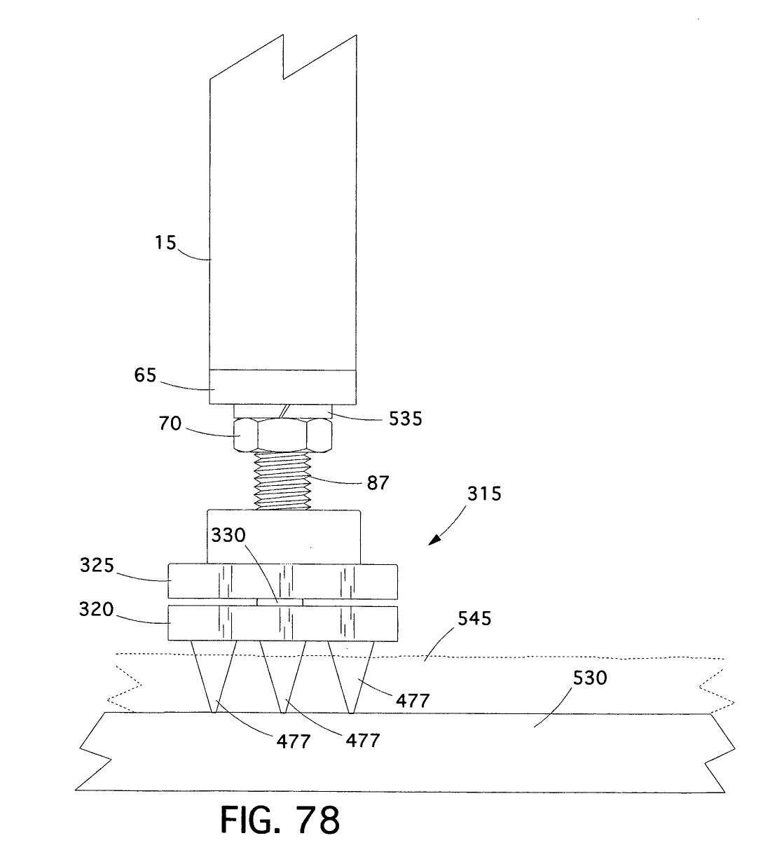

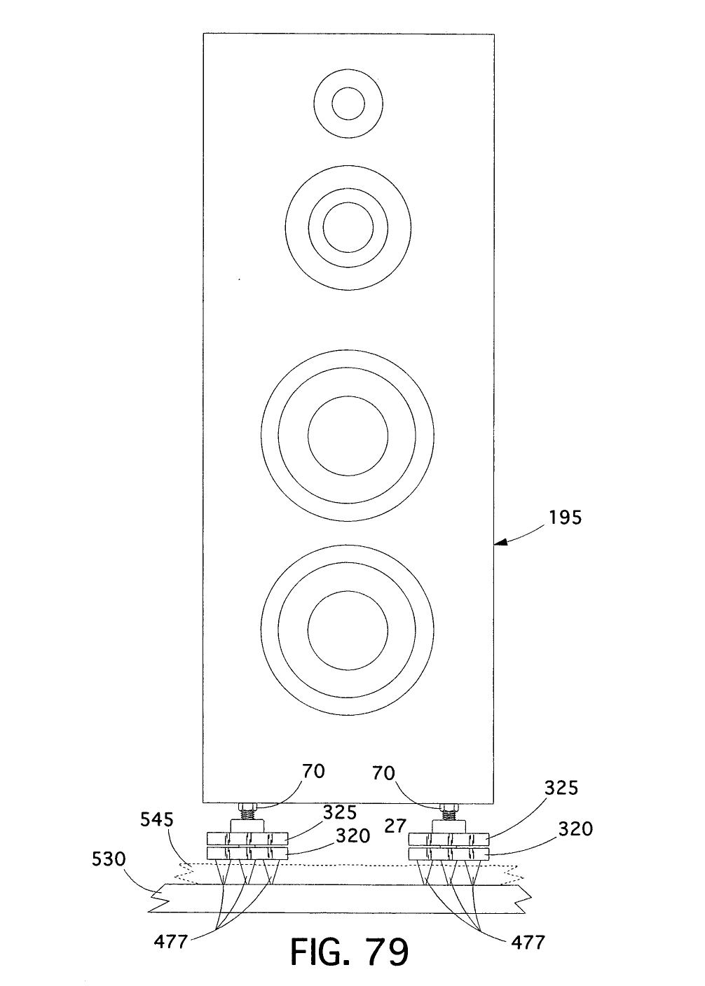

Referring to FIG. 78, the flat interface surface of a typical to disc 320 of a bearing mount 315 can be replaced with one comprising spikes 477 that can penetrate into a carpeted surface 545 to firmly plant the associated column 15 despite the resilient nature of carpet and carpet padding. In FIG. 79, a similar bearing mount with a spiked interface surface 477 can be used to provide proper footing for a large loudspeaker 195 that includes threaded bores on its bottom side for receiving mounts or supporting feet therein.

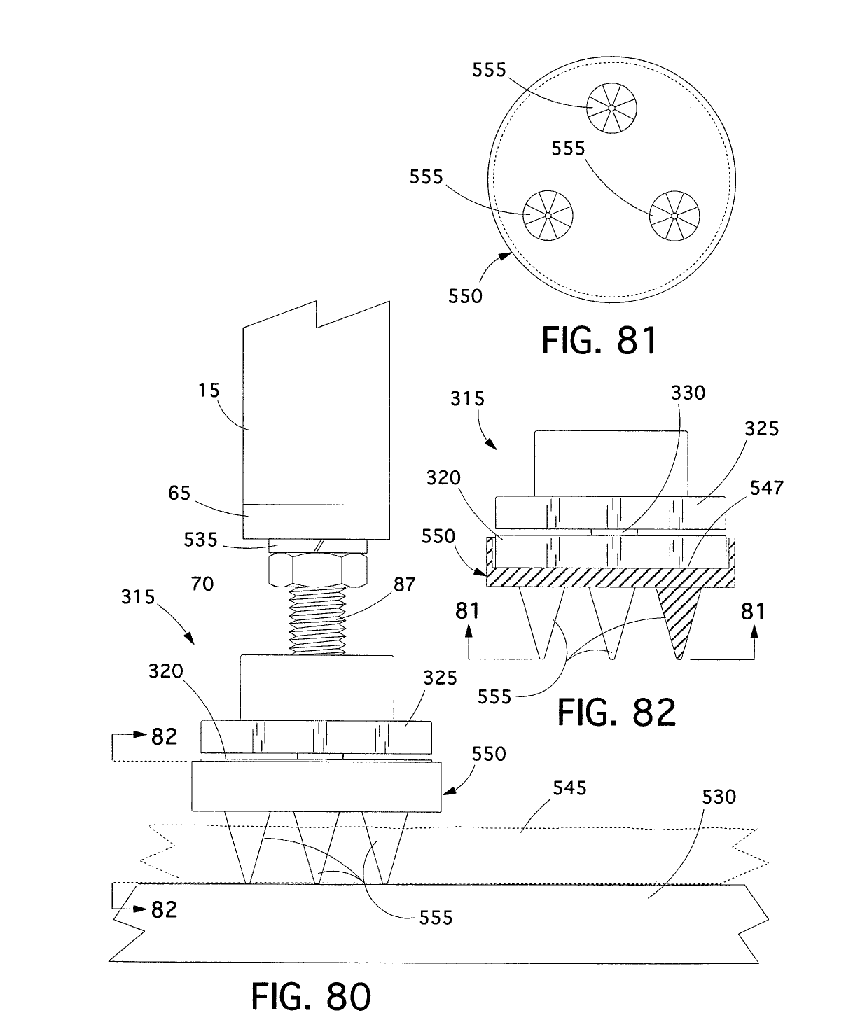

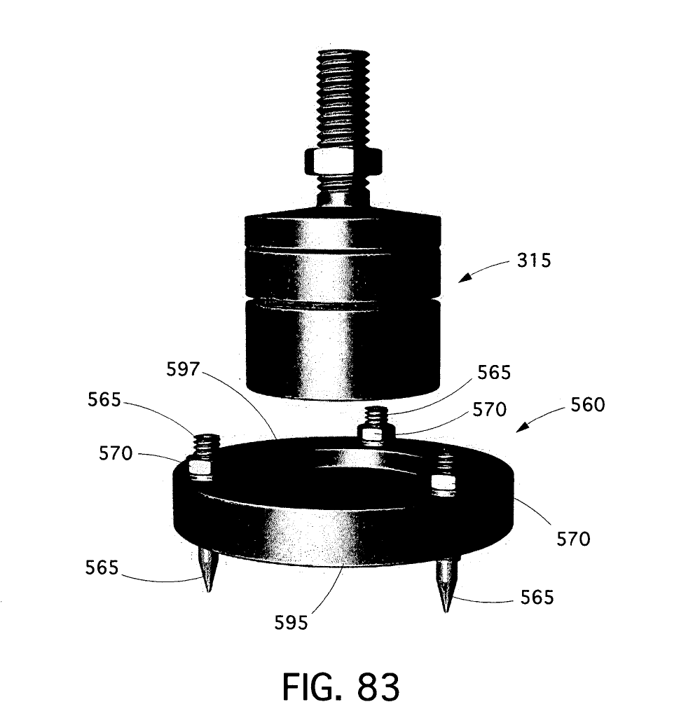

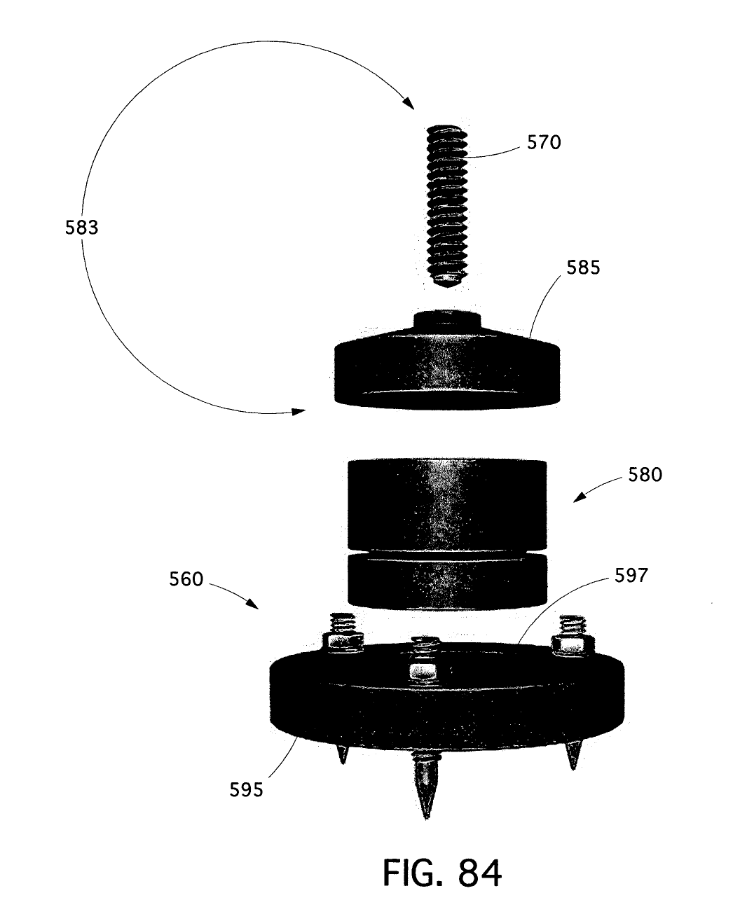

As an alternative to providing a bearing mount with a spiked interface surface, a spiked adapter 550 can be utilized to provide proper footing for a standard flat faced bearing mount 315 on a carpeted surface as shown in FIGS. 80-82. The spiked adapter typically comprises a platform that has three spikes 555 protruding from its bottom side that like the spiked surface of the bearing mount of FIG. 78 can penetrate a carpet. Generally, the spike adapter includes a counter-bore 547 in its top surface having a diameter only slightly larger than the diameter of the mount it is adapted to receive. FIGS. 83 illustrates a second type of spike adapter 560 wherein hardened steel spikes 565 are threadably received into the plate 595 forming the base of the adapter, and can be adjusted to account for localized differences in the height of the floor on which they are being placed. A lock nut 570 and washer 575 are provided to lock the spikes in placed once they have been adjusted. Of course, other means can be utilized for adjusting the spikes independently. For instance, the spikes could comprise threadless rods sliding in an unthreaded bore and a setscrew incident on the bore could be used to lock the spikes in place. Like the first adapter, a counter bore 597 is provided in the second type adapter to receive and hold the associated bearing mount 315.

Referring to FIG. 84, with the use of a bearing adapter 583 the spike adapter 560 can be used with a studless bearing 580 of the types described herein or a prior art bearing mount. The bearing adapter comprises a counter bored cupped piece 585 that fits over the end of a bearing mount. The center of the side opposite the cupped side has a threaded bore through its center that is sized to receive a stud 87 therethrough. The stud can be then threaded into the end of a rack column as shown in the other Figures. It is appreciated that the bearing adapter can also be used in conjunction with a studless bearing mount to support components by flipping the bearing mount and the bearing adapter 180 degrees and securing it to a cross bar member 35.

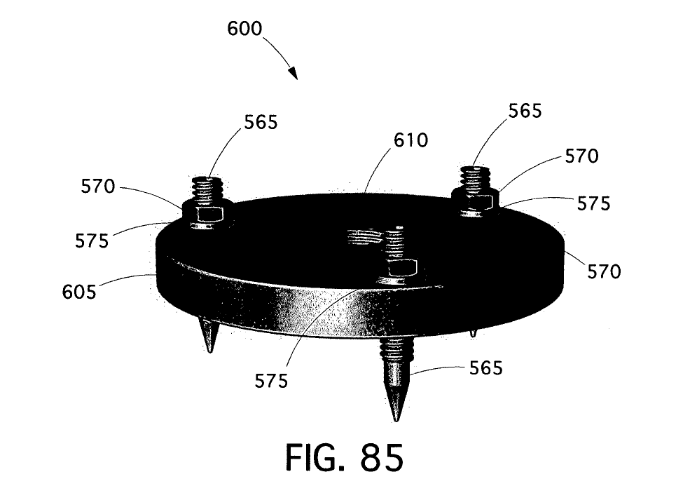

Referring to FIGS. 85 & 86, an adapter 600 configured for use with upright mounts with stud 87 is illustrated. It comprises a plate 605 or disk that has three adjustable spikes 565 (as described above concerning the spike adapter 560) spaced at 120 degree intervals around its periphery and the adapter has a threaded center bore sized to receive the stud 87 of a mount, such as a self-adjusting platform mount 290, therein. Ideally, three or four of these adapters 600 along with associated mounts can be used to support components or loudspeaker on a carpeted floor without the use of a rack. For very heavy components such as some amplifiers, a fifth adapter and associated mount can be placed at the center of the component. Alternatively, the adapter can be used on solid surfaces with floor protector discs 615 placed over the ends of the spikes so that the spikes will not damage the floor.

The various adapters are described and shown herein being used with particular types of mounts, such as the bearing mount 315 or the self-adjustable mount 290. It is appreciated, however, that any suitable type of mount can be used in conjunction with the adapters. The specific choice of what adapter to use is wholly dependent on the component to be supported and the level of vibration control desired. Further, it is to be appreciated that the various adapters described herein are merely exemplary. For instance variations of the adapters can be of different shapes, such as square or rectangular instead of circular. The adapters can have four or more spikes instead of the illustrated three. Additionally, although the platforms associated with the adapter are typically machined from an aluminum alloy but they can also be made of steel, another metal or a polymeric composite.

A Triangle Rack System

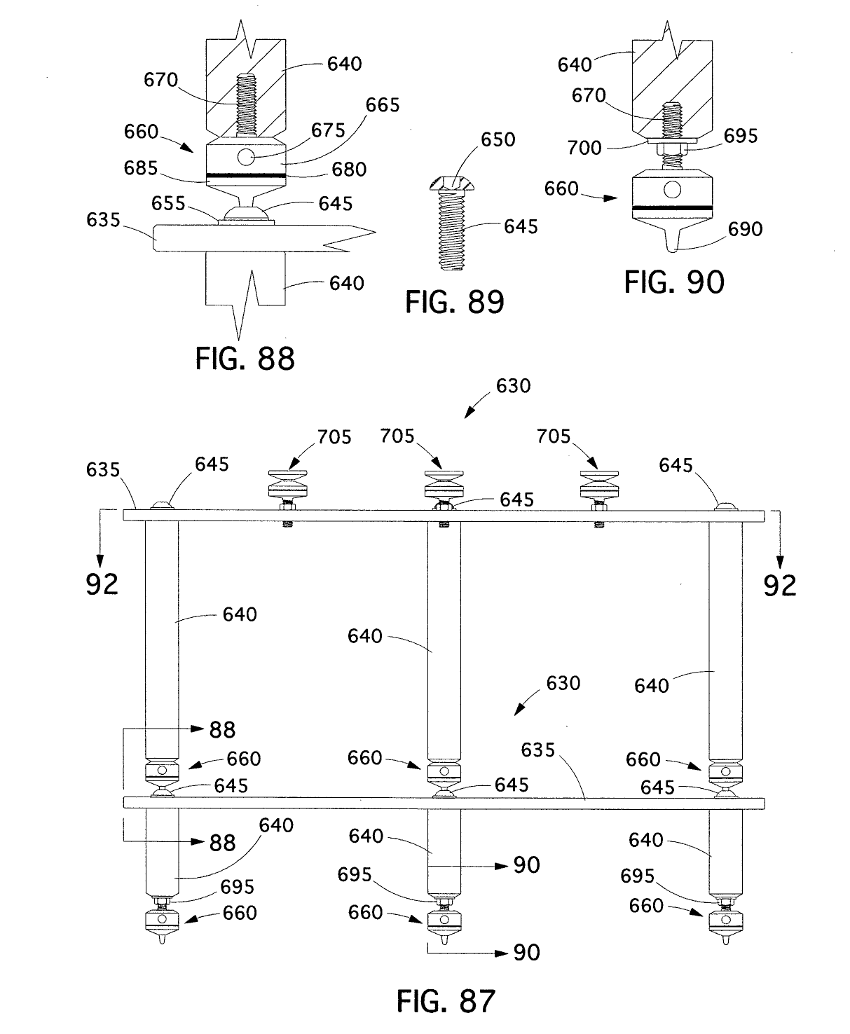

Referring to FIGS. 87-95, an alternate rack system 630 and its various elements are illustrated. The rack structure comprises modular elements including at least; (1) one platform 635; (2) three columns 640; (3) and, three column mounts 660, attached to the bottoms of the columns 640. The rack 630, when fitted with various mounts, can support one piece of audio, video, electrical, mechanical, optical, or other equipment, which may benefit from this invention.

In the preferred embodiments, the platform 635 is a three-sided ½″ thick aluminum plate with at least one hole 715 in each corner, and the columns 640 are 1½″ diameter solid aluminum rod with threaded counter-bores at both ends. The columns 640 may be specified in various lengths to produce the desired platform 635 height. Each column 640 is attached to one corner of the platform 635 with one ½″13 alloy steel hex-socket cap-screw 645 (and a washer 655) which passes through a hole 715 in the platform 635 to engage the threaded counter-bore of the column 640.

FIG. 88 shows a column mount 660 comprised of; (1) an aluminum upper disc 665 having an integral ⅜″16 threaded stud 670, and an installation/removal hole 675; (2) a viscoelastic layer 680; (3) and a stainless-steel bottom disc 685 with a tapered extension having a hemispherical terminus 690. The viscoelastic layer 680 is adhesive bonded to both the upper disc 665 and the bottom disc 685, so as to produce a constrained-layer design which dampens vibratory energy by conversion to low-grade-heat. One column mount 660 is attached the bottom of each column 640 by means of the stud 670 which engages the threaded counter-bore of the column 640.

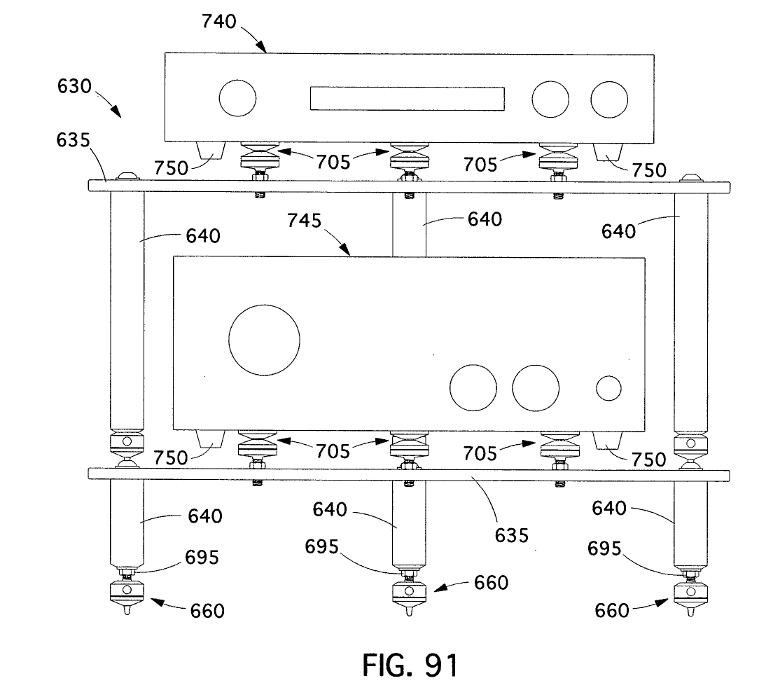

Multiple level racks can be configured by vertically “stacking” one rack 630 upon the other, as depicted in FIGS. 87 and 91. FIG. 88 details the typical interface or connection that provides this stacking feature. The hemispherical tip 690 of the column mount 660 is received by the hex-angular counter-bore 650 in the head of the cap-screw 645, shown in FIG. 89.

As shown in FIGS. 87, 90, and 91, when a single-level rack 630, or the bottom level of a multi-level rack system is placed on the floor, the column mounts 660 include a jam-nut 695 and a washer 700 to allow for leveling of the rack 630.

The illustrated alternate rack system 630 has a platform 635 width of about 16″, and a depth of about 18″. The lower level rack 630 has a height of approximately 6½″, and the upper level rack 630 has a height of about 13″.

The dimensions of the elements can vary depending on the intended use of rack system 630 and the material from which it is constructed. Further, the elements can be fabricated from different materials including steel, magnesium, and other metals, plastics, composites, and wood.

Referring to FIGS. 87 and 91, a two-level (stacked) rack system is shown. FIG. 91 shows a cd player 740 and a (taller) amplifier 745 that are each supported by three mounts 705 which are identical to those detailed in FIGS. 44 and 45 of this application, and as previously described herein. Alternately, bearing mounts as shown in FIGS. 46-52, and any other previously described mounts could be substituted.

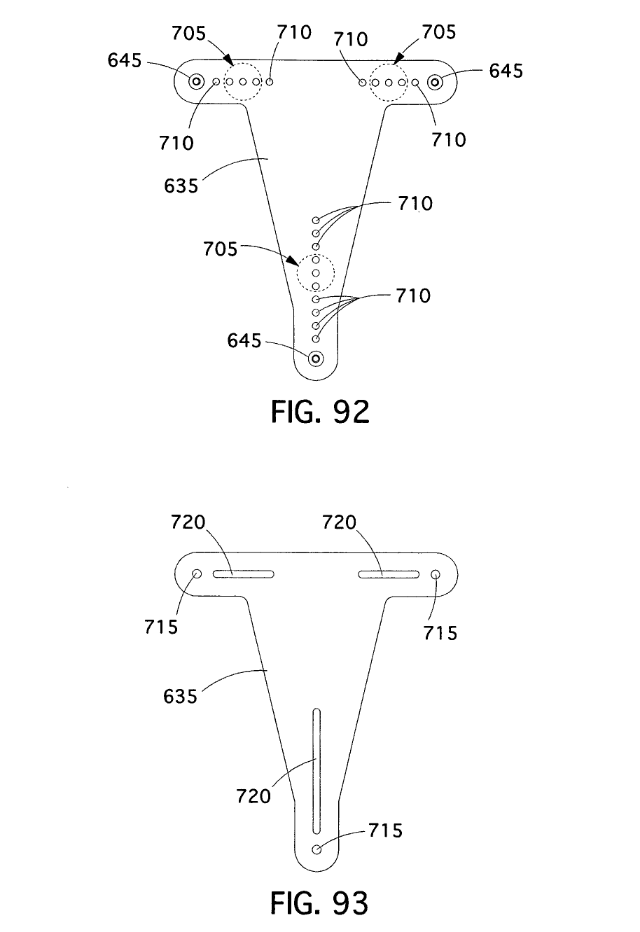

As shown in FIG. 92, the mounts 705 are threaded/attached to the platform 635 by engagement with any one in each of three series of threaded holes 710 that allow various incremental spacing to support equipment of various dimensions. The mounts 705 are leveled and locked in place with a jam-nut 90.

An alternate embodiment of a platform 635 is shown in FIG. 93, whereby three slots 720 are provided to receive the mounts 705. The slots 720 allow infinite adjustment of the positions of the mounts 705 within their respective lengths. The mounts 705 are attached to the platform 635 by the clamping force of two jam-nuts 90—one above and one below the platform 635.

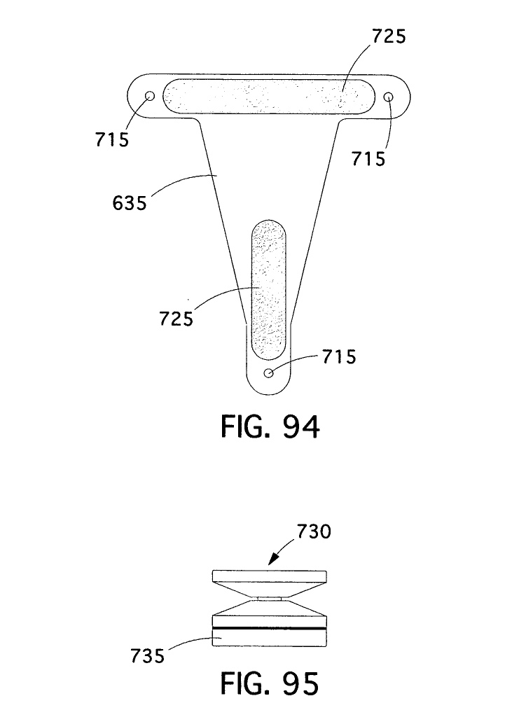

A final alternate embodiment of a platform 635 is shown in FIG. 94, whereby three horizontal depressions 720, approximately ⅛″ deep, are provided to receive the mounts 730 depicted in FIG. 95. The mounts 730 are identical to those detailed in FIGS. 44 and 45 of this application, except they have a flat disc 735 instead of the former threaded stud 87. Alternately, bearing mounts as shown in FIGS. 46-52, and any other previously described mounts could be so modified and thereby substituted. The mounts 730 are retained in the slightly wider depressions 735 but can be “slid” into any positions within their respective lengths.

Finally, as an alternative to the preferred column mounts 660 of this rack system 630, any of the previously depicted and discussed mounts and adapters can be fitted to the bottoms of the columns 640 for support of the rack 630 at the floor.

In conclusion, while prior art rack systems may employ similar materials in a shelf-less, three column and platform, stackable design, none except the subject rack system 630 are inclusive of column mounts 660, or equivalent devices. The unique column mounts 660 provide effective isolation and damping of harmful vibratory energy emanating from the floor, the supported equipment, and from the air, while isolating individual levels from one another in a multi-level, stacked configuration.

Moreover, this alternate (shelf-less) rack system 630 includes the full array of unique mounts as herein described, for direct support, and performance enhancement of audio, video, and other types of equipment.

Alternative Embodiments

The embodiments of the rack system, the various types of mounts, and the several adapters as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

For instance, the various dimensions, sizes and materials specified for use in the rack, mounts and adapters can be varied as would be obvious to one of ordinary skill in the art with the benefit of this disclosure. Although the term disc has been used extensively herein in reference to circular platforms that make up the mounts, it is not to be so narrowly construed. Rather, alternative embodiment mounts can comprise square, rectangular, oval or any other suitably shaped discs. Additionally, the various elements and subcomponents of each of the described rack, mounts and adapter can as appropriate be interchanged with each other to configure alternative embodiment racks, mounts or adapters that are not specifically illustrated herein.

I claim:

1. A rack system for supporting audio/video components, the rack system comprising:
a plurality of generally horizontal elongated elements, each comprised of strut channel and including a longitudinally extending slot;
a plurality of generally vertical elongated elements, the vertical elongated elements adapted to couple with the horizontal elongated elements to form a free standing structure;
a plurality of mounts, each mount of the plurality of mounts including an at least partially threaded stud extending from one side thereof; and
a plurality of channel nuts with threaded bores, each channel nut being adapted to (1) be received into the elongated slot of at least one of the horizontal elongated elements and (2) braced against an inside surface of the horizontal elongated element, and (3) receive the at least partially threaded stud in the threaded bore.

2. The rack system of claim 1, wherein the rack system includes floor spikes.

3. The rack system of claim 1, wherein the rack system does not include shelves.

4. The rack system of claim 1, wherein the plurality of vertical elongated elements comprise strut channel.

5. The rack system of claim 1, wherein at least one of the group of vertical and horizontal elongated elements includes a constrained layer of viscoelastic material.

6. The rack system of claim 1, wherein at least one mount of the plurality of mounts comprises both a constrained layer of viscoelastic material and a bearing assembly.

7. The rack system of claim 1, wherein at least one mount of the plurality of mounts comprises a tungsten carbide ball bearing sandwiched between a top disc and a bottom disc, at least one of the top and bottom discs including a tungsten carbide bearing race.

8. The rack system of claim 1, wherein at least one mount of the plurality of mounts comprises a ball bearing sandwiched between top and bottom discs, and an O-ring attached to one of the top and bottom disks, the O-ring being adapted to limit the lateral movement of the top disk relative to the bottom disk.

9. The rack system of claim 1, further comprising a plurality of floor support mounts adapted to provide an interface between a generally horizontal surface and a bottom end of the vertical elongated elements, the mount including at least one of the group of a constrained layer of viscoelastic material, and a bearing assembly.

10. The rack system of claim 9, further comprising a platform with top and bottom surfaces, the platform having: (1) three or more spikes extending from the bottom surface, the spikes being adapted to one or both of (a) at least partially penetrate a carpeting covering the generally horizontal surface, and (b) substantially compress the carpeting at points of contact with the spikes; and (2) a counter bore in the top surface, the counter bore being adapted to receive a floor support mount therein.

11. The rack system of claim 1, wherein at least one mount of the plurality of mounts comprises a constrained layer of viscoelastic material.

12. A rack having a structure comprised of strut channel in combination with at least one audio/video component supported on the rack.

13. The combination of claim 12, wherein the strut channel is steel and has a zinc-plated finish applied thereto.

14. The combination of claim 12, wherein the rack does not comprise shelves.

15. The combination of claim 12, wherein the rack further comprises at least three mounts, the mounts being coupled with the rack and having the at least one component resting on the at least three mounts.

16. The combination of claim 12, wherein each of the at least three mounts further include a threaded stud extending from one side thereof.

17. The combination of claim 12, wherein the rack further comprises one or more cantilevered levels, each cantilever level comprising one or more pieces of generally horizontally orientated elongated channel strut, the one or more pieces of generally horizontally orientated elongated channel strut having first and second ends, wherein only the first end is attached to a vertically orientated elongated strut channel.

18. A rack for supporting audio and video components, the rack comprising:
a plurality of substantially vertical columns, the columns comprised of strut channel;
a plurality of substantially horizontal first elongated members, the first elongated members comprised of strut channel, each of the plurality of the first elongated members being attached to at least one of the vertical columns;
a plurality of substantially horizontal second elongated members, each of the plurality of second elongated members being attached to at least one of the first elongated members, the combination of the columns, the first elongated members and the second elongated members forming a self-supporting structure; and
at least three mounts coupled with the self supporting structure.

19. The rack of claim 18, wherein one or more of the at least three mounts is directly coupled to one of the first or second elongated members.

20. The rack of claim 18, wherein one or more of the at least three mounts comprises a top disc, the top disc being pivotally coupled to a bottom portion of the mount.
